(19) United States
(12) Patent Application Publication
(10) Pub. No.: US 2025/0393031 A1
(43) Pub. Date: Dec. 25, 2025

(54) EXTENDED BANDWIDTH OPERATION

(71) Applicant: Samsung Electronics Co., Ltd., Suwon-si (KR)

(72) Inventors: Vishnu Vardhan Ratnam, Plano, TX (US); Rubayet Shafin, Allen, TX (US); Bilal Sadiq, Frisco, TX (US); Boon Loong Ng, Plano, TX (US); Peshal Nayak, Plano, TX (US); Yue Qi, Plano, TX (US)

(21) Appl. No.: 19/232,759

(22) Filed: Jun. 9, 2025

Related U.S. Application Data
(60) Provisional application No. 63/662,258, filed on Jun. 20, 2024.
(60) Provisional application No. 63/692,377, filed on Sep. 9, 2024.
(60) Provisional application No. 63/709,007, filed on Oct. 18, 2024.
(60) Provisional application No. 63/749,239, filed on Jan. 24, 2025.

(51) Int. Cl. H04W 72/04; H04W 88/08

(52) U.S. Cl. CPC H04W 72/04; H04W 88/08

(57) ABSTRACT

An access point (AP) in a wireless network includes a memory and a processor coupled to the memory. The processor is configured to determine an extended bandwidth indicating a maximum operating bandwidth that is different than a nominal bandwidth of a basic service set (BSS) associated with the AP. The processor is further configured to transmit, to one or more STAs, a frame that indicates the extended bandwidth and an operation to be performed using the extended bandwidth.

### CROSS-REFERENCE TO RELATED APPLICATION(S)

This application claims the benefit of priority from U.S. Provisional Application No. 63/662,258, entitled “ENABLING EXTENDED BANDWIDTH OPERATION BY AN AP FOR SPECIFIC FEATURES,” filed Jun. 20, 2024; U.S. Provisional Application No. 63/692,377, entitled “ENABLING EXTENDED BANDWIDTH OPERATION BY AN AP FOR SPECIFIC FEATURES,” filed Sep. 9, 2024; U.S. Provisional Application No. 63/709,007, entitled “ENABLING EXTENDED BANDWIDTH OPERATION BY AN AP FOR SPECIFIC FEATURES,” filed Oct. 18, 2024; and U.S. Provisional Application No. 63/749,239, entitled “ENABLING EXTENDED BANDWIDTH OPERATION BY AN AP FOR SPECIFIC FEATURES,” filed Jan. 24, 2025, all which are incorporated herein by reference in their entirety.

### TECHNICAL FIELD

This disclosure relates generally to a wireless communication system, and more particularly to, for example, but not limited to, bandwidths in wireless communication systems. Some aspects are related to indicating an extended bandwidth for certain operations.

### BACKGROUND

Wireless local area network (WLAN) technology has evolved toward increasing data rates and continues its growth in various markets such as home, enterprise and hotspots over the years since the late 1990s. WLAN allows devices to access the internet in the 2.4 GHz, 5 GHz, 6 GHz or 60 GHz frequency bands. WLANs are based on the Institute of Electrical and Electronic Engineers (IEEE) 802.11 standards. IEEE 802.11 family of standards aims to increase speed and reliability and to extend the operating range of wireless networks.

WLAN devices are increasingly required to support a variety of delay-sensitive applications or real-time applications such as augmented reality (AR), robotics, artificial intelligence (AI), cloud computing, and unmanned vehicles. To implement extremely low latency and extremely high throughput required by such applications, multi-link operation (MLO) has been suggested for the WLAN. The WLAN is formed within a limited area such as a home, school, apartment, or office building by WLAN devices. Each WLAN device may have one or more stations (STAs) such as the access point (AP) STA and the non-access point (non-AP) STA.

The MLO may enable a non-AP multi-link device (MLD) to set up multiple links with an AP MLD. Each of multiple links may enable channel access and frame exchanges between the non-AP MLD and the AP MLD independently, which may reduce latency and increase throughput.

In some examples, the AP or STA can use or rely on different applicable bandwidth for a given feature specified in the IEEE 802.11 family of standards. Accordingly, a mechanism to accommodate different applicable bandwidths by feature or by STA is desired.

The description set forth in the background section should not be assumed to be prior art merely because it is set forth in the background section. The background section may describe aspects or embodiments of the present disclosure.

### SUMMARY

An aspect of the present disclosure provides for an access point (AP) in a wireless network, including a memory and a processor coupled to the memory, the processor to cause determining an extended bandwidth indicating a maximum operating bandwidth that is different than a nominal bandwidth of a basic service set (BSS) associated with the AP and transmitting, to one or more stations (STAs), a frame that indicates the extended bandwidth and an operation to be performed using the extended bandwidth.

In an embodiment, the processor is further to cause transmitting a second frame including an operation element indicating a channel width, wherein the processor is to determine the nominal bandwidth based at least in part on the channel width.

In an embodiment, the processor is further to cause transmitting, to a second AP, a request frame including the extended bandwidth and a request to utilize the extended bandwidth on an indicated channel for a duration and receive, from the second AP, a response frame indicating whether the request is accepted or rejected by the second AP.

In an embodiment, the frame includes at least one of information configured to indicate whether the extended bandwidth is present in the frame or information configured to indicate a center frequency of different segments of the extended bandwidth.

In an embodiment, the processor is further to cause transmitting, to the STA, a second frame that includes one or more statistics indicative of a usage of the extended bandwidth and the nominal bandwidth.

In an embodiment, the frame includes one or more fields associated with the operation indicating whether the operation utilizes the nominal bandwidth or the extended bandwidth or the frame includes the one or more fields associated with the operation indicating a bandwidth applicable for the operation.

In an embodiment, the processor is further to cause transmitting an element or field associated with the operation within the frame or a second frame based at least in part on initiating the operation, wherein the element or field includes an indication of the extended bandwidth for the operation.

In an embodiment, the frame includes at least one of a start time indicating a time when the extended bandwidth is applied for a transmission or an extended bandwidth duration indicating a duration the extended bandwidth is applied for operation.

In an embodiment, the transmission of a second frame using the extended bandwidth is preceded by a transmission of a control frame including an indication corresponding to a transmission time of a first data frame utilizing the extended bandwidth.

In an embodiment, the frame includes a resource unit (RU) allocation, wherein the subset of the set of associated STAs is allocated to a first RU and the remaining subset of the set of associated STAs is allocated to a second RU.

An aspect of the present disclosure provides for a station (STA) in a wireless network, including a memory and a processor coupled to the memory, the processor to cause receiving, from an access point (AP), a frame that indicates an extended bandwidth and an operation to be performed using the extended bandwidth, wherein the extended bandwidth indicates a maximum operating bandwidth that is different than a nominal bandwidth of a basic service set (BSS) associated with the AP and performing the operation at the extended bandwidth based at least in part on the receiving the frame.

In an embodiment, the processor is further to cause receiving, from the AP, a second frame including an operation element indicating a channel width and determining the nominal bandwidth based at least in part on the channel width.

In an embodiment, the second frame includes a plurality of operation elements indicating a plurality of channel widths, wherein the plurality of operation elements includes the operation element indicating the channel width and determining the nominal bandwidth associated with the STA based at least in part on an order the plurality of operation elements is decoded.

In an embodiment, the processor is further to cause transmitting, to the AP, a request frame that requests the AP initiates the operation at the extended bandwidth with an initial control frame and receiving, from the AP, a response frame indicating the request is accepted.

In an embodiment, the frame includes at least one of information configured to indicate whether the extended bandwidth is present in the frame or information configured to indicate a center frequency of different segments of the extended bandwidth.

In an embodiment, the processor is further to cause receiving, from the AP, a second frame that includes one or more statistics indicative of a usage of the extended bandwidth and the nominal bandwidth.

In an embodiment, the frame includes one or more fields associated with the operation indicating whether the operation utilizes the nominal bandwidth or the extended bandwidth or the frame includes the one or more fields associated with the operation indicating a bandwidth applicable for the operation.

In an embodiment, the frame includes at least one of a start time indicating a time when the extended bandwidth is applied for a transmission or an extended bandwidth duration indicating a duration the extended bandwidth is applied for the operation.

In an embodiment, the frame is an operation frame indicating parameters for the operation including the extended bandwidth.

In an embodiment, the frame includes a resource unit (RU) allocation and where the processor is further to cause determining whether the STA is configured to perform the operation at the extended bandwidth and selecting an RU allocation index for RU indication from the RU allocation based at least in part on determining whether the STA is configured to perform the operation at the extended bandwidth.

### BRIEF DESCRIPTION OF THE DRAWINGS

FIG. 1 shows an example of a wireless network in accordance with an embodiment.

FIG. 2A shows an example of AP in accordance with an embodiment.

FIG. 2B shows an example of STA in accordance with an embodiment.

FIG. 3 shows an example of multi-link communication operation in accordance with an embodiment.

FIGS. 4A and 4B show examples of channelization for different bandwidths in accordance with an embodiment.

FIG. 5 shows an example of a operation element in accordance with an embodiment.

FIGS. 6A and 6B show example capabilities elements transmitted in accordance with an embodiment.

FIGS. 7A and 7B show example operating mode field formats in accordance with an embodiment.

FIGS. 8A and 8B show example extended channel width element in accordance with an embodiment.

FIG. 9 shows an example operating element in accordance with an embodiment.

FIGS. 10A and 10B show an example extended channel width element in accordance with an embodiment.

FIG. 11 shows an example DP control element in accordance with an embodiment.

FIGS. 12A and 12B show example NPCA control elements for a NPCA operation in accordance with an embodiment.

FIG. 13 shows an example FFR control element in accordance with an embodiment.

FIG. 14 shows an example DBS control element in accordance with an embodiment.

FIG. 15 shows an example of a process for using extended bandwidth in accordance with an embodiment.

FIG. 16 shows another example of a process for using extended bandwidth in accordance with an embodiment.

FIG. 17 shows an example of a process for using extended bandwidth in accordance with an embodiment.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

The detailed description set forth below, in connection with the appended drawings, is intended as a description of various implementations and is not intended to represent the only implementations in which the subject technology may be practiced. Rather, the detailed description includes specific details for the purpose of providing a thorough understanding of the inventive subject matter. As those skilled in the art would realize, the described implementations may be modified in various ways, all without departing from the scope of the present disclosure. Accordingly, the drawings and description are to be regarded as illustrative in nature and not restrictive. Like reference numerals designate like elements.

The following description is directed to certain implementations for the purpose of describing the innovative aspects of this disclosure. However, a person having ordinary skill in the art will readily recognize that the teachings herein can be applied in a multitude of different ways. The examples in this disclosure are based on WLAN communication according to the Institute of Electrical and Electronics Engineers (IEEE) 802.11 standard, including IEEE 802.11be standard and any future amendments to the IEEE 802.11 standard. However, the described embodiments may be implemented in any device, system or network that is capable of transmitting and receiving radio frequency (RF) signals according to the IEEE 802.11 standard, the Bluetooth standard, Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1×EV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), 5G NR (New Radio), AMPS, or other known signals that are used to communicate within a wireless, cellular or internet of things (IoT) network, such as a system utilizing 3G, 4G, 5G, 6G, or further implementations thereof, technology.

Depending on the network type, other well-known terms may be used instead of “access point” or “AP,” such as “router” or “gateway.” For the sake of convenience, the term “AP” is used in this disclosure to refer to network infrastructure components that provide wireless access to remote terminals. In WLAN, given that the AP also contends for the wireless channel, the AP may also be referred to as a STA. Also, depending on the network type, other well-known terms may be used instead of “station” or “STA,” such as “mobile station,” “subscriber station,” “remote terminal,” “user equipment,” “wireless terminal,” or “user device.” For the sake of convenience, the terms “station” and “STA” are used in this disclosure to refer to remote wireless equipment that wirelessly accesses an AP or contends for a wireless channel in a WLAN, whether the STA is a mobile device (such as a mobile telephone or smartphone) or is normally considered a stationary device (such as a desktop computer, AP, media player, stationary sensor, television, etc.).

Multi-link operation (MLO) is a key feature that is currently being developed by the standards body for next generation extremely high throughput (EHT) Wi-Fi systems in IEEE 802.11be. The Wi-Fi devices that support MLO are referred to as multi-link devices (MLD). With MLO, it is possible for a non-AP MLD to discover, authenticate, associate, and set up multiple links with an AP MLD. Channel access and frame exchange is possible on each link between the AP MLD and non-AP MLD.

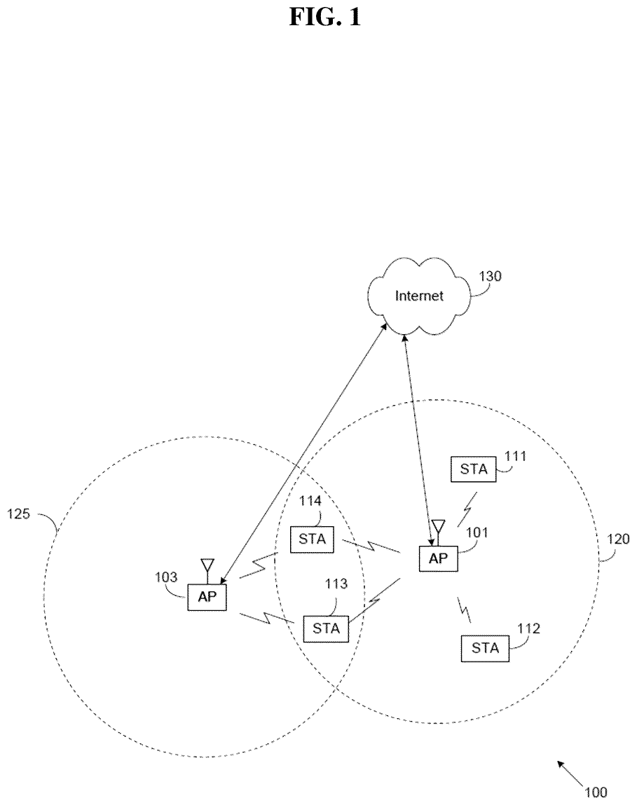

FIG. 1 shows an example of a wireless network 100 in accordance with an embodiment. The embodiment of the wireless network 100 shown in FIG. 1 is for illustrative purposes only. Other embodiments of the wireless network 100 could be used without departing from the scope of this disclosure.

As shown in FIG. 1, the wireless network 100 may include a plurality of wireless communication devices. Each wireless communication device may include one or more stations (STAs). The STA may be a logical entity that is a singly addressable instance of a medium access control (MAC) layer and a physical (PHY) layer interface to the wireless medium. The STA may be classified into an access point (AP) STA and a non-access point (non-AP) STA. The AP STA may be an entity that provides access to the distribution system service via the wireless medium for associated STAs. The non-AP STA may be a STA that is not contained within an AP-STA. For the sake of simplicity of description, an AP STA may be referred to as an AP and a non-AP STA may be referred to as a STA. In the example of FIG. 1, APs 101 and 103 are wireless communication devices, each of which may include one or more AP STAs. In such embodiments, APs 101 and 103 may be AP multi-link device (MLD). Similarly, STAs 111-114 are wireless communication devices, each of which may include one or more non-AP STAs. In such embodiments, STAs 111-114 may be non-AP MLD.

The APs 101 and 103 communicate with at least one network 130, such as the Internet, a proprietary Internet Protocol (IP) network, or other data network. The AP 101 provides wireless access to the network 130 for a plurality of stations (STAs) 111-114 with a coverage are 120 of the AP 101. The APs 101 and 103 may communicate with each other and with the STAs using Wi-Fi or other WLAN communication techniques.

Depending on the network type, other well-known terms may be used instead of “access point” or “AP,” such as “router” or “gateway.” For the sake of convenience, the term “AP” is used in this disclosure to refer to network infrastructure components that provide wireless access to remote terminals. In WLAN, given that the AP also contends for the wireless channel, the AP may also be referred to as a STA. Also, depending on the network type, other well-known terms may be used instead of “station” or “STA,” such as “mobile station,” “subscriber station,” “remote terminal,” “user equipment,” “wireless terminal,” or “user device.” For the sake of convenience, the terms “station” and “STA” are used in this disclosure to refer to remote wireless equipment that wirelessly accesses an AP or contends for a wireless channel in a WLAN, whether the STA is a mobile device (such as a mobile telephone or smartphone) or is normally considered a stationary device (such as a desktop computer, AP, media player, stationary sensor, television, etc.).

In FIG. 1, dotted lines show the approximate extents of the coverage area 120 and 125 of APs 101 and 103, which are shown as approximately circular for the purposes of illustration and explanation. It should be clearly understood that coverage areas associated with APs, such as the coverage areas 120 and 125, may have other shapes, including irregular shapes, depending on the configuration of the APs.

As described in more detail below, one or more of the APs may include circuitry and/or programming for management of MU-MIMO and OFDMA channel sounding in WLANs. Although FIG. 1 shows one example of a wireless network 100, various changes may be made to FIG. 1. For example, the wireless network 100 could include any number of APs and any number of STAs in any suitable arrangement. Also, the AP 101 could communicate directly with any number of STAs and provide those STAs with wireless broadband access to the network 130. Similarly, each AP 101 and 103 could communicate directly with the network 130 and provides STAs with direct wireless broadband access to the network 130. Further, the APs 101 and/or 103 could provide access to other or additional external networks, such as external telephone networks or other types of data networks.

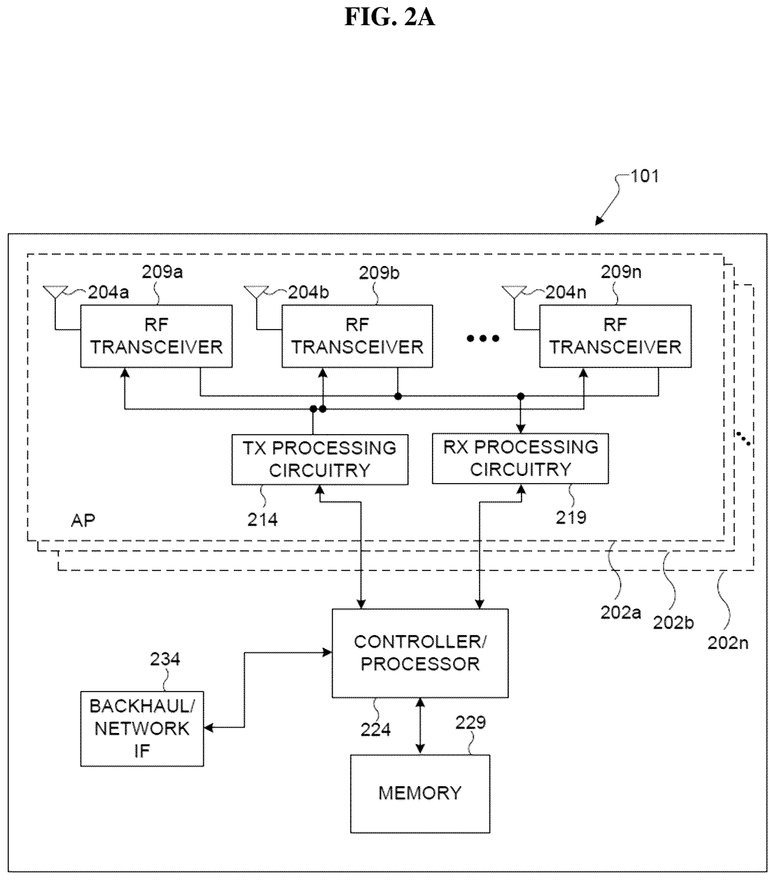

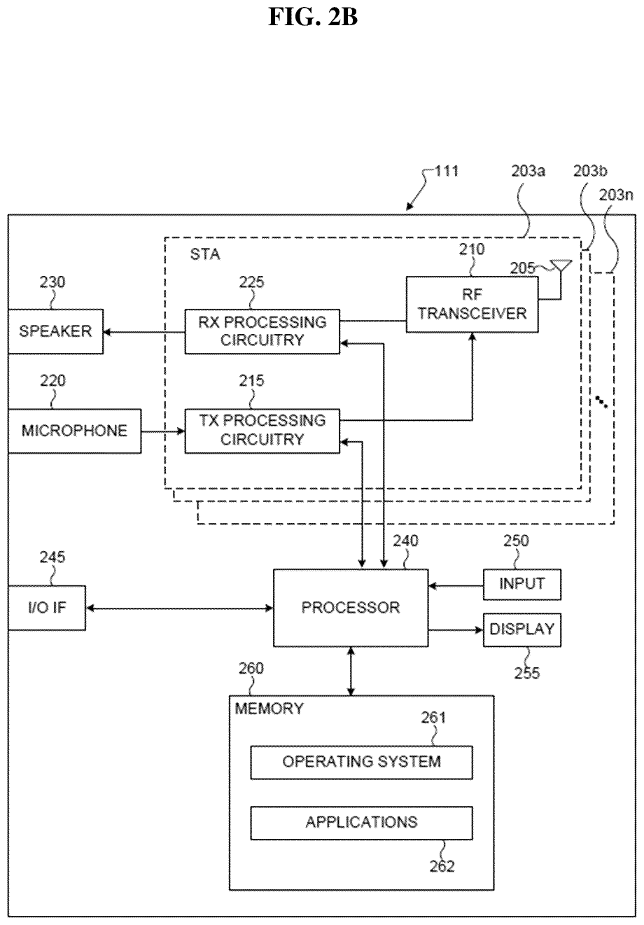

FIG. 2A shows an example of AP 101 in accordance with an embodiment. The embodiment of the AP 101 shown in FIG. 2A is for illustrative purposes, and the AP 103 of FIG. 1 could have the same or similar configuration. However, APs come in a wide range of configurations, and FIG. 2A does not limit the scope of this disclosure to any particular implementations of an AP.

As shown in FIG. 2A, the AP 101 may include multiple antennas 204a-204n, multiple radio frequency (RF) transceivers 209a-209n, transmit (TX) processing circuitry 214, and receive (RX) processing circuitry 219. The AP 101 also may include a controller/processor 224, a memory 229, and a backhaul or network interface 234. The RF transceivers 209a-209n receive, from the antennas 204a-204n, incoming RF signals, such as signals transmitted by STAs in the network 100. The RF transceivers 209a-209n down-convert the incoming RF signals to generate intermediate (IF) or baseband signals. The IF or baseband signals are sent to the RX processing circuitry 219, which generates processed baseband signals by filtering, decoding, and/or digitizing the baseband or IF signals. The RX processing circuitry 219 transmits the processed baseband signals to the controller/processor 224 for further processing.

The TX processing circuitry 214 receives analog or digital data (such as voice data, web data, e-mail, or interactive video game data) from the controller/processor 224. The TX processing circuitry 214 encodes, multiplexes, and/or digitizes the outgoing baseband data to generate processed baseband or IF signals. The RF transceivers 209a-209n receive the outgoing processed baseband or IF signals from the TX processing circuitry 214 and up-converts the baseband or IF signals to RF signals that are transmitted via the antennas 204a-204n.

The controller/processor 224 can include one or more processors or other processing devices that control the overall operation of the AP 101. For example, the controller/processor 224 could control the reception of uplink signals and the transmission of downlink signals by the RF transceivers 209a-209n, the RX processing circuitry 219, and the TX processing circuitry 214 in accordance with well-known principles. The controller/processor 224 could support additional functions as well, such as more advanced wireless communication functions. For instance, the controller/processor 224 could support beam forming or directional routing operations in which outgoing signals from multiple antennas 204a-204n are weighted differently to effectively steer the outgoing signals in a desired direction. The controller/processor 224 could also support OFDMA operations in which outgoing signals are assigned to different subsets of subcarriers for different recipients (e.g., different STAs 111-114). Any of a wide variety of other functions could be supported in the AP 101 by the controller/processor 224 including a combination of DL MU-MIMO and OFDMA in the same transmit opportunity. In some embodiments, the controller/processor 224 may include at least one microprocessor or microcontroller. The controller/processor 224 is also capable of executing programs and other processes resident in the memory 229, such as an OS. The controller/processor 224 can move data into or out of the memory 229 as required by an executing process.

The controller/processor 224 is also coupled to the backhaul or network interface 234. The backhaul or network interface 234 allows the AP 101 to communicate with other devices or systems over a backhaul connection or over a network. The interface 234 could support communications over any suitable wired or wireless connection(s). For example, the interface 234 could allow the AP 101 to communicate over a wired or wireless local area network or over a wired or wireless connection to a larger network (such as the Internet). The interface 234 may include any suitable structure supporting communications over a wired or wireless connection, such as an Ethernet or RF transceiver. The memory 229 is coupled to the controller/processor 224. Part of the memory 229 could include a RAM, and another part of the memory 229 could include a Flash memory or other ROM.

As described in more detail below, the AP 101 may include circuitry and/or programming for management of channel sounding procedures in WLANs. Although FIG. 2A illustrates one example of AP 101, various changes may be made to FIG. 2A. For example, the AP 101 could include any number of each component shown in FIG. 2A. As a particular example, an AP could include a number of interfaces 234, and the controller/processor 224 could support routing functions to route data between different network addresses. As another example, while shown as including a single instance of TX processing circuitry 214 and a single instance of RX processing circuitry 219, the AP 101 could include multiple instances of each (such as one per RF transceiver). Alternatively, only one antenna and RF transceiver path may be included, such as in legacy APs. Also, various components in FIG. 2A could be combined, further subdivided, or omitted and additional components could be added according to particular needs.

As shown in FIG. 2A, in some embodiment, the AP 101 may be an AP MLD that includes multiple APs 202a-202n. Each AP 202a-202n is affiliated with the AP MLD 101 and includes multiple antennas 204a-204n, multiple radio frequency (RF) transceivers 209a-209n, transmit (TX) processing circuitry 214, and receive (RX) processing circuitry 219. Each APs 202a-202n may independently communicate with the controller/processor 224 and other components of the AP MLD 101. FIG. 2A shows that each AP 202a-202n has separate multiple antennas, but each AP 202a-202n can share multiple antennas 204a-204n without needing separate multiple antennas. Each AP 202a-202n may represent a physical (PHY) layer and a lower media access control (MAC) layer.

FIG. 2B shows an example of STA 111 in accordance with an embodiment. The embodiment of the STA 111 shown in FIG. 2B is for illustrative purposes, and the STAs 111-114 of FIG. 1 could have the same or similar configuration. However, STAs come in a wide variety of configurations, and FIG. 2B does not limit the scope of this disclosure to any particular implementation of a STA.

As shown in FIG. 2B, the STA 111 may include antenna(s) 205, a RF transceiver 210, TX processing circuitry 215, a microphone 220, and RX processing circuitry 225. The STA 111 also may include a speaker 230, a controller/processor 240, an input/output (I/O) interface (IF) 245, a touchscreen 250, a display 255, and a memory 260. The memory 260 may include an operating system (OS) 261 and one or more applications 262.

The RF transceiver 210 receives, from the antenna(s) 205, an incoming RF signal transmitted by an AP of the network 100. The RF transceiver 210 down-converts the incoming RF signal to generate an IF or baseband signal. The IF or baseband signal is sent to the RX processing circuitry 225, which generates a processed baseband signal by filtering, decoding, and/or digitizing the baseband or IF signal. The RX processing circuitry 225 transmits the processed baseband signal to the speaker 230 (such as for voice data) or to the controller/processor 240 for further processing (such as for web browsing data).

The TX processing circuitry 215 receives analog or digital voice data from the microphone 220 or other outgoing baseband data (such as web data, e-mail, or interactive video game data) from the controller/processor 240. The TX processing circuitry 215 encodes, multiplexes, and/or digitizes the outgoing baseband data to generate a processed baseband or IF signal. The RF transceiver 210 receives the outgoing processed baseband or IF signal from the TX processing circuitry 215 and up-converts the baseband or IF signal to an RF signal that is transmitted via the antenna(s) 205.

The controller/processor 240 can include one or more processors and execute the basic OS program 261 stored in the memory 260 in order to control the overall operation of the STA 111. In one such operation, the controller/processor 240 controls the reception of downlink signals and the transmission of uplink signals by the RF transceiver 210, the RX processing circuitry 225, and the TX processing circuitry 215 in accordance with well-known principles. The controller/processor 240 can also include processing circuitry configured to provide management of channel sounding procedures in WLANs. In some embodiments, the controller/processor 240 may include at least one microprocessor or microcontroller.

The controller/processor 240 is also capable of executing other processes and programs resident in the memory 260, such as operations for management of channel sounding procedures in WLANs. The controller/processor 240 can move data into or out of the memory 260 as required by an executing process. In some embodiments, the controller/processor 240 is configured to execute a plurality of applications 262, such as applications for channel sounding, including feedback computation based on a received null data packet announcement (NDPA) and null data packet (NDP) and transmitting the beamforming feedback report in response to a trigger frame (TF). The controller/processor 240 can operate the plurality of applications 262 based on the OS program 261 or in response to a signal received from an AP. The controller/processor 240 is also coupled to the I/O interface 245, which provides STA 111 with the ability to connect to other devices such as laptop computers and handheld computers. The I/O interface 245 is the communication path between these accessories and the main controller/processor 240.

The controller/processor 240 is also coupled to the input 250 (such as touchscreen) and the display 255. The operator of the STA 111 can use the input 250 to enter data into the STA 111. The display 255 may be a liquid crystal display, light emitting diode display, or other display capable of rendering text and/or at least limited graphics, such as from web sites. The memory 260 is coupled to the controller/processor 240. Part of the memory 260 could include a random access memory (RAM), and another part of the memory 260 could include a Flash memory or other read-only memory (ROM).

Although FIG. 2B shows one example of STA 111, various changes may be made to FIG. 2B. For example, various components in FIG. 2B could be combined, further subdivided, or omitted and additional components could be added according to particular needs. In particular examples, the STA 111 may include any number of antenna(s) 205 for MIMO communication with an AP 101. In another example, the STA 111 may not include voice communication or the controller/processor 240 could be divided into multiple processors, such as one or more central processing units (CPUs) and one or more graphics processing units (GPUs). Also, while FIG. 2B illustrates the STA 111 configured as a mobile telephone or smartphone, STAs could be configured to operate as other types of mobile or stationary devices.

As shown in FIG. 2B, in some embodiment, the STA 111 may be a non-AP MLD that includes multiple STAs 203a-203n. Each STA 203a-203n is affiliated with the non-AP MLD 111 and includes an antenna(s) 205, a RF transceiver 210, TX processing circuitry 215, and RX processing circuitry 225. Each STAs 203a-203n may independently communicate with the controller/processor 240 and other components of the non-AP MLD 111. FIG. 2B shows that each STA 203a-203n has a separate antenna, but each STA 203a-203n can share the antenna 205 without needing separate antennas. Each STA 203a-203n may represent a physical (PHY) layer and a lower media access control (MAC) layer.

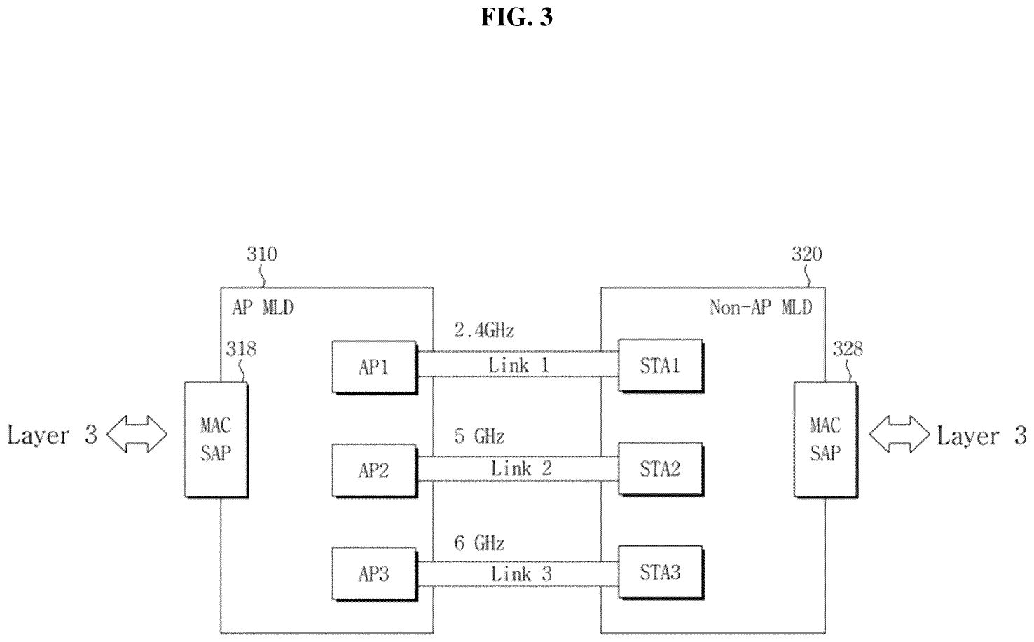

FIG. 3 shows an example of multi-link communication operation in accordance with an embodiment. The multi-link communication operation may be usable in IEEE 802.11be standard and any future amendments to IEEE 802.11 standard. In FIG. 3, an AP MLD 310 may be the wireless communication device 101 and 103 in FIG. 1 and a non-AP MLD 220 may be one of the wireless communication devices 111-114 in FIG. 1.

As shown in FIG. 3, the AP MLD 310 may include a plurality of affiliated APs, for example, including AP 1, AP 2, and AP 3. Each affiliated AP may include a PHY interface to wireless medium (Link 1, Link 2, or Link 3). The AP MLD 310 may include a single MAC service access point (SAP) 318 through which the affiliated APs of the AP MLD 310 communicate with a higher layer (Layer 3 or network layer). Each affiliated AP of the AP MLD 310 may have a MAC address (lower MAC address) different from any other affiliated APs of the AP MLD 310. The AP MLD 310 may have a MLD MAC address (upper MAC address) and the affiliated APs share the single MAC SAP 318 to Layer 3. Thus, the affiliated APs share a single IP address, and Layer 3 recognizes the AP MLD 310 by assigning the single IP address.

The non-AP MLD 320 may include a plurality of affiliated STAs, for example, including STA 1, STA 2, and STA 3. Each affiliated STA may include a PHY interface to the wireless medium (Link 1, Link 2, or Link 3). The non-AP MLD 320 may include a single MAC SAP 328 through which the affiliated STAs of the non-AP MLD 320 communicate with a higher layer (Layer 3 or network layer). Each affiliated STA of the non-AP MLD 320 may have a MAC address (lower MAC address) different from any other affiliated STAs of the non-AP MLD 320. The non-AP MLD 320 may have a MLD MAC address (upper MAC address) and the affiliated STAs share the single MAC SAP 328 to Layer 3. Thus, the affiliated STAs share a single IP address, and Layer 3 recognizes the non-AP MLD 320 by assigning the single IP address.

The AP MLD 310 and the non-AP MLD 320 may set up multiple links between their affiliate APs and STAs. In this example, the AP 1 and the STA 1 may set up Link 1 which operates in 2.4 GHz band. Similarly, the AP 2 and the STA 2 may set up Link 2 which operates in 5 GHz band, and the AP 3 and the STA 3 may set up Link 3 which operates in 6 GHz band. Each link may enable channel access and frame exchange between the AP MLD 310 and the non-AP MLD 320 independently, which may increase date throughput and reduce latency. Upon associating with an AP MLD on a set of links (setup links), each non-AP device is assigned a unique association identifier (AID).

The following documents are hereby incorporated by reference in their entirety into the present disclosure as if fully set forth herein: i) IEEE 802.11-2020, “Wireless LAN Medium Access Control (MAC) and Physical Layer (PHY) Specifications,” ii) IEEE 802.11ax, “Wireless LAN Medium Access Control (MAC) and Physical Layer (PHY) Specifications,” iii) IEEE P802.11be/D5.1, “Wireless LAN Medium Access Control (MAC) and Physical Layer (PHY) Specifications”, and iv) IEEEP802.11bk/D1.0.

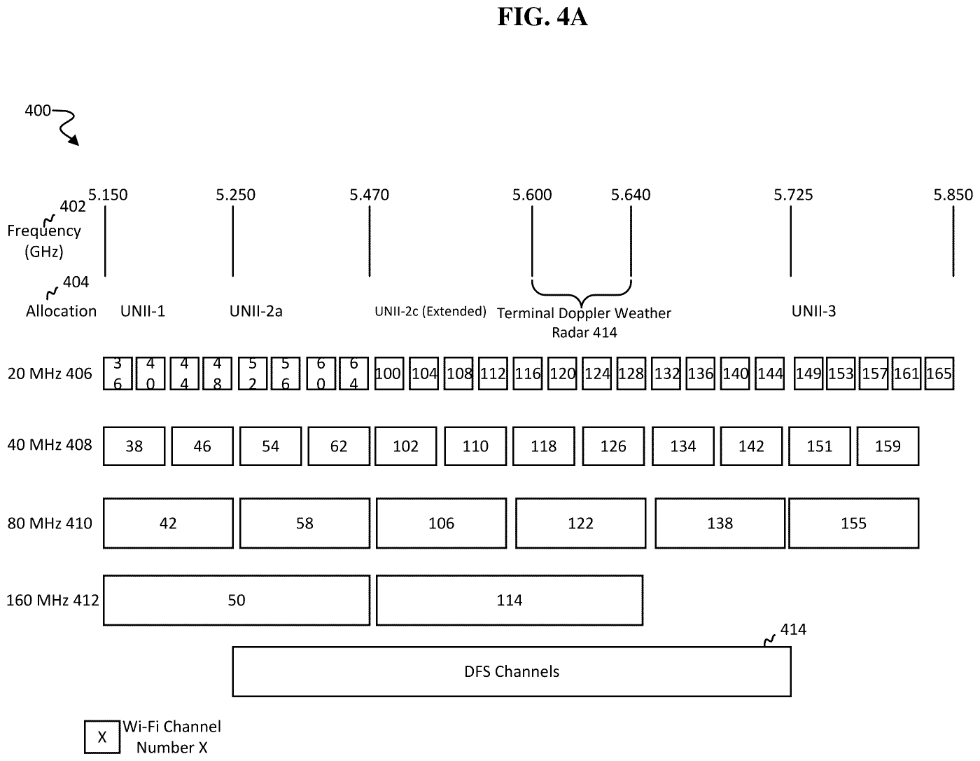

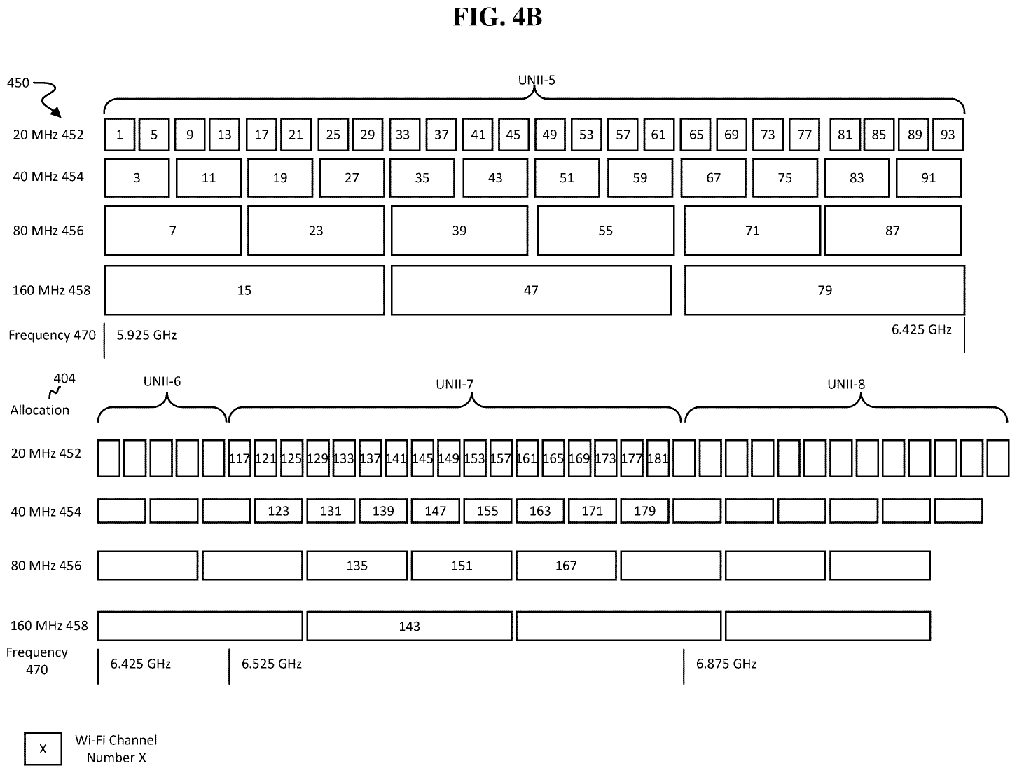

FIGS. 4A and 4B show example channelization's in accordance with an embodiment. For example, FIG. 4A illustrates a channelization 400 for a 5 gigahertz (GHz) Wi-Fi band for different bandwidths and FIG. 4B illustrates a channelization 450 for a 6 GHz Wi-Fi band for a standard power access point (AP). The channelization 400 and channelization 450 depicted in FIGS. 4A and 4B are for explanatory and illustration purposes and FIGS. 4A and 4B do not limit the scope of this disclosure to any particular implementation.

In some examples, a wireless local network (WLAN) (e.g., a Wi-Fi network) can offer several unlicensed frequency bands for communication. For example, the communication can be in 2.4 GHz, 5 GHz, and 6 GHz frequency ranges. In some examples, an available bandwidth is dependent on a country the WLAN is in. In most examples, there is an 80 megahertz (MHz) bandwidth available at 2.4 GHz, 500 MHz bandwidth available at 5 GHz, and 1200 MHz available at 6 GHz.

In a Wi-Fi network, a basic service set (BSS) refers to a network topology including one access point (AP) or an AP multi-link device (MLD), and all the non-AP devices associated with the one AP or the AP MLD. In some embodiments, each BSS defines an operating bandwidth that indicates frequency resources that the devices belonging to the BSS can utilize for transmission. In at least one embodiment, each BSS can also indicate rules on how the devices belonging to the BSS can contend for the operating bandwidth. That is, the Wi-Fi BSS can define one of the 20 MHz channels in its operating bandwidth as a primary channel and accordingly, any device in that BSS is allowed to initiate transmission if the primary channel is sensed as idle (e.g., there is no current data transmission over the primary channel). In some examples, the device belonging to the BSS can sense whether the channel is idle after performing a random back-off operation. In some embodiments, the transmission is restricted to the designated primary 20 MHz channel and a duration of the transmission is called a transmit opportunity (TXOP) duration. In some instances, the device can additionally transmit data on an idle non-primary channel of the BSS. For example, if any non-primary 20 MHz channel (e.g., a 20 MHz channel that lies within the operating bandwidth but is not the primary channel) is sensed as idle for a point coordination function inter frame spacing (PIFS) duration before a time when the TXOP starts on the primary channel for a Wi-Fi device, the device can transmit data on the sensed idle non-primary channel. In some embodiments, transmitting data (e.g., at least partially) on the non-primary channel can be referred to as channel bonding. In some examples, the channel bonding can be enhanced with a concept of preamble puncturing (e.g., the AP can transmit a punctured portion of a spectrum channel).

In at least one embodiment, sensing the primary channel as being in an idle state is a prerequisite for any communication by devices of a BSS. In some embodiments, the Wi-Fi network can be an example of a dense deployment of access points (APs). In such embodiments, an interference from one transmitting BSS to its neighboring BSS can be quite strong. For example, a transmission in the first BSS can cause the neighboring BSS to sense channels used by the first BSS as busy (e.g., actively transmitting data). Such interference can prevent or delay channel access by the neighboring BSS that operate on the same bandwidth—e.g., overlapping BSS (OBSS). Accordingly, to ensure that communications in one AP's BSS does not cause a channel delay to a neighboring AP's BSS, neighboring APs usually select orthogonal operating bandwidths for their BSSs. In non-enterprise scenarios (e.g., non-commercial scenarios), channel selection can happen in a decentralized way by observing beacons of neighboring APs to know the neighboring AP's operating bandwidth. In enterprise scenarios, channel selection for the AP can happen in a centralized way using a graph or channelization as shown in FIGS. 4A and 4B. Specifically, FIG. 4A can illustrate a channelization 400 for a 5 GHz Wi-Fi band and FIG. 4B can illustrate a channelization 450 for a 6 GHz Wi-Fi band.

Referring to FIG. 4A, the channelization 400 can illustrate an assignment of Wi-Fi channels in a 5 GHz band. For example, the channelization 400 can illustrate a respective frequency 402 (e.g., 5.150 GHz, 5.250 GHz, 5.470 GHz, 5.600 GHz, 5.640 GHz, 5.725 GHz, 5.800 GHz) and allocation 404 (e.g., illustrating unlicensed national information infrastructure (UNII) radio bands, as defined by the United States Federal Communications Commission (FCC)). For example, the allocation 404 could indicate one of a UNII-1, a UNII-2a, UNII-2c (extended), and UNII-3. In some embodiments, each allocation 404 is associated with a different frequency range—e.g., UNII-1 is associated with a frequency range 5.150-5.250 GHz, UNII-2a is associated with a frequency range 5.250-5.470 GHz, UNII-2c is associated with a frequency range 5.470 to 5.725 GHz, and UNII-3 is associated with a frequency range 5.725-5.850 GHz. In at least one embodiment, each allocation 404 can be associated with different conditions or properties. For example, UNII-1 can be associated with a 1,000 milliwatt (mW) transmitting power and can be utilized indoor or outdoor. In some embodiments, the UNII-1 does not need dynamic frequency selection (DFS) channels. In at least one embodiment, DFS channels are potential Wi-Fi channels that share the spectrum with weather radar and radar systems. That is, Wi-Fi devices can listen for radar events and stop using the DFS channels accordingly. In at least one embodiment, the UNII-2a can be associated with 250 mW antenna gain (e.g., 6 dBi) and can be used indoor or outdoors. In some embodiments, the UNII-2a allocation 404 can utilize DFS channels. In some embodiments, the UNII-2c can be associated with the 250 mW antenna gain, be used indoor or outdoors, and can utilize DFS channels. In at least one embodiment, a frequency range 5.600 to 5.640 GHz is utilized by terminal doppler weather radar 414—e.g., used by radar devices. In at least one embodiment, the UNII-3 is associated with the 1000 mW effective isotropic radiated power (EIRP), can be utilized indoor or outdoors, and DFS channels are not necessary.

In at least one embodiment, the channelization 400 illustrates Wi-Fi channels for each respective channel width—e.g., for 20 MHz 406, 40 MHz 408, 80 MHz 410, and 160 MHz 412. Accordingly, channelization 400 can show the channel allocation for a respective Wi-Fi channel number or illustrate a frequency and channel width of a respective Wi-Fi channel number. For example, a Wi-Fi channel 36 can be a 20 MHz 406 channel operating at 5.150 GHz. In at least one embodiment, wider Wi-Fi channels are created by bonding multiple adjacent 20 MHz 406 channels. For example, channels 36 and 40 can be bound together to form 40 MHz 408 channel 38. Similarly, channel 38 and 46 can be bound together to form 80 MHz 410 channel 42 and channel 42 and 58 can be bound together to form 160 MHz 412 channel 50.

In one embodiment, due to a limited bandwidth of 5 GHz band (e.g., based on limitations in sub-bands like the terminal doppler weather radar 414), enterprise AP typically use a BSS bandwidth of 80 MHz. In such embodiments, the AP can utilize five (5) orthogonal channels as illustrated in channelization 400.

Referring to FIG. 4B, the channelization 450 can illustrate an assignment of Wi-Fi channels in a 6 GHz band for a standard power AP. For example, the channelization 450 can illustrate a respective frequency 470 (e.g., 5.925 GHz, 6.425 GHz, 6.525 GHz, 6.875 GHz) and allocation 404 (e.g., illustrating unlicensed national information infrastructure (UNII) radio bands, as defined by the United States Federal Communications Commission (FCC)). For example, the allocation 404 could indicate one of a UNII-5, a UNII-6, UNII-7, and UNII-8. In some embodiments, each allocation 404 is associated with a different frequency range—e.g., UNII-5 is associated with a frequency range 5.925-6.425 GHz, UNII-6 is associated with a frequency range 6.425-6.525 GHz, UNII-7 is associated with a frequency range 6.525 to 6.875 GHz, and UNII-8 is associated with a frequency range 6.875-7.125 GHz. In at least one embodiment, some allocations 404 can have reserved Wi-Fi channels—e.g., there are currently no Wi-Fi channels assigned in the blank boxes illustrated in FIG. 4B.

In at least one embodiment, the channelization 450 illustrates Wi-Fi channels for each respective channel width—e.g., for 20 MHz 452, 40 MHz 454, 80 MHz 456, and 160 MHz 458. Accordingly, channelization 450 can show the channel allocation for a respective Wi-Fi channel number or illustrate a frequency and channel width of a respective Wi-Fi channel number. For example, a Wi-Fi channel 1 can be a 20 MHz 452 channel operating at 5.925 GHz. In at least one embodiment, wider Wi-Fi channels are created by bonding multiple adjacent 20 MHz 452 channels. For example, channels 1 and 5 can be bound together to form 40 MHz 454 channel 3. Similarly, channel 3 and 11 can be bound together to form 80 MHz 456 channel 7 and channel 7 and 23 can be bound together to form 160 MHz 458 channel 15.

In at least one embodiment, an enterprise AP (e.g., with standard power) in the 6 Ghz band typically uses a BSS bandwidth of 80 MHz, enabling 9 orthogonal channels as illustrated in channelization 450.

In at least some embodiments, the AP can indicate current parameters of the BSS by transmitting one or more operation elements. For example, the AP can indicate the current parameters of the BSS in one or more operation elements in a beacons frame, a probe response frame, and/or an association response frame. In one or more embodiments, the AP uses a primary channel field of a high throughput (HT) operations element to indicate a current primary 20 MHz channel. In some embodiments, the AP can also utilize a secondary channel offset field to indicate a location of a secondary 20 MHz channel if the channel width is greater than or equal to 40 MHz (e.g., CW≥40 MHz). In some embodiments, a channel center frequency segment 0 (CCFS0) field and/or a channel center frequency segment 1 (CCFS1) field of a very high throughput (VHT) operation element (e.g., or a high efficiency (HE) element if the VHT element is not present) can indicate a location of the primary and secondary 80 MHz channels. In one or more embodiments, the CCFS0 and/or the CCFS1 fields of an extremely high throughput (EHT) operations elements indicate primary and secondary 160 MHz channels. Additionally, a station (STA) channel width field of a high throughput (HT) operation element, a channel width of the VHT operation element, the channel width of the HE operation element, the channel width of the EHT operation element to jointly indicate the operating CW of the BSS. In at least one embodiment, when operating in channels where HT and/or VHT elements are not present and these fields are replicated in the HE operations element. For example, the operation of EHT STAs in an EHT BSS is controlled by an HT operation element, HE operation element, and an EHT operation element if operating in the 2.4 GHz band. In other examples, the operation of the EHT STAs in the EHT BSS is controlled by the HT operation, VHT operation (if present), HE operation element, and the EHT operation element if operating in the 5 GHz band. In still other examples, the operation of the EHT STAs in the EHT BSS is controlled by the HE operation element and EHT operation element if operating in the 6 GHz band. In at least one embodiment, a basic HT/VHT/HE/EHT modulation coding scheme (MCS) and number of spatial streams (NSS) set of the HT/VHT/HE/EHT operation element is what all STAs in the BSS support at the minimum for a respective HT/VHT/HE/EHT physical layer protocol data units (PPDUs).

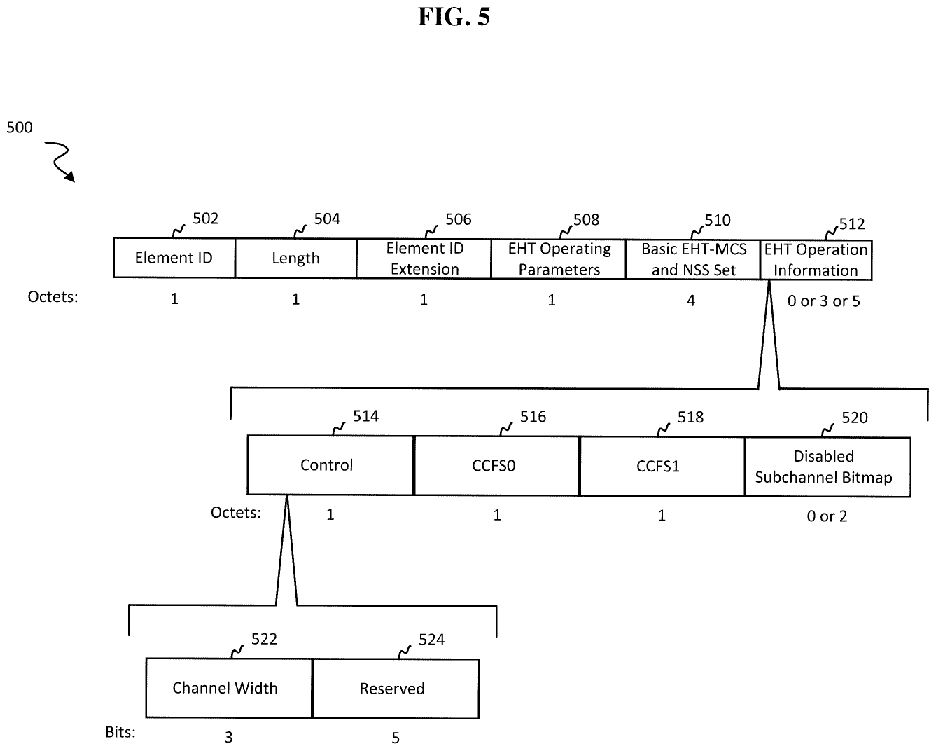

Referring to FIG. 5, an example EHT operation element 500 is illustrated. In at least one embodiment, the EHT operation element 500 can illustrate a maximum set of parameters that can be used by an AP or its associated STAs for initiating transmission within the BSS. It should be noted that the format depicted in FIG. 5 is for explanatory and illustration purpose.

In at least one embodiment, the EHT operation element 500 can include an element identification (ID) 502, a length 504, an element identification extension 506, EHT operating parameters 508, basic EHT-MCS and NSS set 510, and EHT operation information 512. In some embodiments, the element ID 502 can identify the EHT operation element 500. In at least one embodiment, the length 504 can indicate a length of the EHT operation element 500. In some embodiments, the element ID extension 506 can include additional identification information. In at least one embodiment, the EHT operating parameters can indicate the parameters that the AP or associated STAs can use. In at least one embodiment, the basic EHT-MCS and NSS set 510 specifies a basic EHT-MCS and/or NSS that must be supported by all EHT STAs in that BSS for both transmission and reception. In at least one embodiment, the EHT operation information 512 can include a control field 514, a CCFS0 516, a CCFS1 518, and a disabled subchannel bitmap 520. In at least one embodiment, the EHT AP can indicate its BSS operating channel width in the channel width field 522. For example, when the EHT AP indicates a different bandwidth for EHT STAs than the non-EHT STAs. In other embodiments, if there is no sperate EHT channel bandwidth, an operating bandwidth of the EHT BSS is determined based on the HE, VHT, and/or HT operating bandwidth as described above. In at least one embodiment, if an EHT channel bandwidth is indicated, an operating center frequency (CCF) is indicated via CCFS0 516 and CCFS1 518. In at least one embodiment, the control 514 can also include a reserved field 524. In some embodiments, the disabled subchannel bitmap 520 is included if there are punctured channels. For example, the disabled subchannel bitmap 520 provides the list of subchannels (e.g., of a 20 MHz) that are punctured in the BSS operating bandwidth—e.g., channels that have one or more slices carved out due to interference.

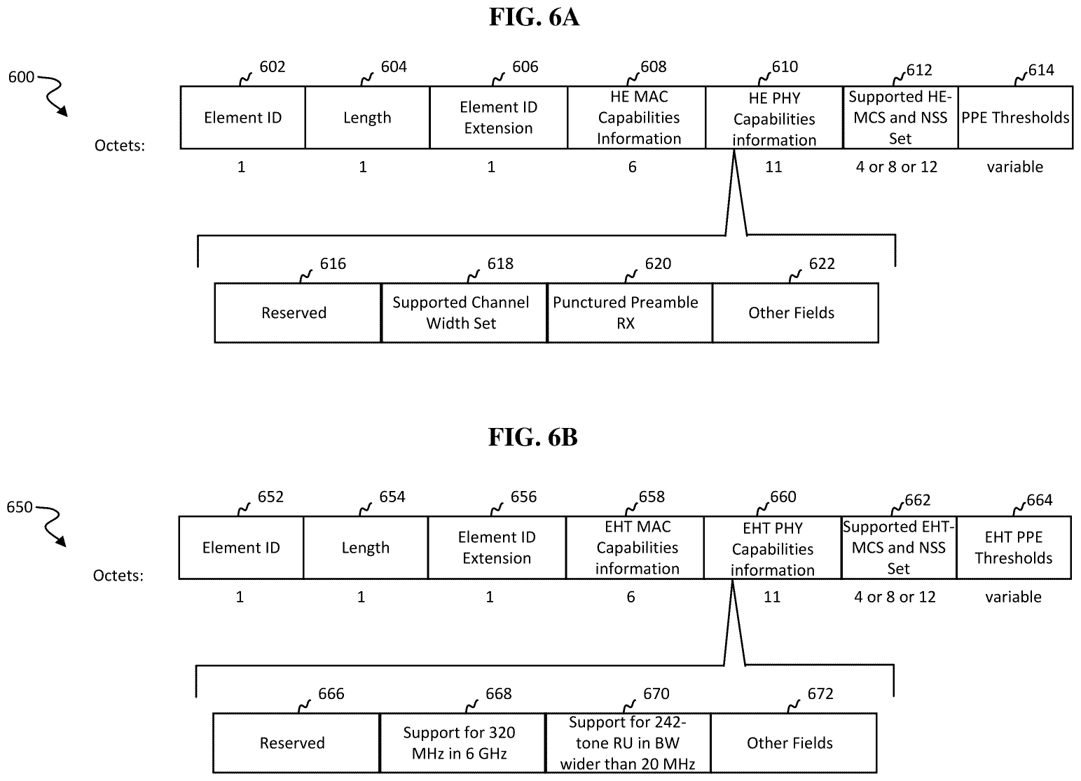

Referring to FIGS. 6A and 6B, in some embodiments, each STA can transmit a capabilities element to indicate different channel widths, modulation and coding schemes (MCS), and a number of spatial streams (NSS) that each STA supports. In one embodiment, FIG. 6A illustrates an HE capabilities element 600 and FIG. 6B illustrates an EHT capabilities element 650. The format depicted in FIGS. 6A and 6B is for explanatory and illustration purposes.

In at least one embodiment, HE capabilities element 600 includes an element identification (ID) 602, a length 604, an element identification extension 606, an HE medium access control (MAC) capabilities 608, HE physical layer (PHY) capabilities information 610, supported HE-MCS and NSS set 612, and a PPE threshold 614 indicating a nominal packet packing value. In at least one embodiment, the element ID 602 identifies the HE capabilities 600. In some embodiments, the length 604 indicates the length of the HE capabilities 600. In some examples, the element ID extension 606 can include additional identification information. In at least one embodiment, the HE MAC capabilities 608 can indicate a set of supported HE MAC features. For example, the HE MAC capabilities 608 can include information regarding a restricted target wake time (TWT) support, triggered transmit opportunity (TXOP) sharing capabilities, etc. In some embodiments, the supported HE-MCS and NSS set 612 indicates a supported combination of HE-MCS and NSS at different PPDU bandwidths. In at least one embodiment, the HE PHY capabilities information 610 includes a reserved field 616, supported channel width set 618, punctured preamble reception (Rx), and other fields 622. In some embodiments, the HE PHY capabilities information 610 includes information regarding channel state information (CSI) resolution or channel sounding information. In at least one embodiment, an STA can indicate the different channels its supports in the supported channel width set 618. In some embodiments, a non-HE and non-EHT STA (e.g., a HT or VHT STA) can also utilize a channel width set field in their respective capabilities element to indicate the different supported channel widths.

Referring to FIG. 6B, in at least one embodiment, the EHT capabilities element 650 can include an element ID 652, a length 654, an element ID extension 656, and EHT MAC capabilities information 658, EHT PHY capabilities information 660, supported EHT-MCS and NSS set 662 and EHT PPE thresholds 664. In at least some embodiments, the fields of the EHT capabilities element 650 can be similar to or convey the same information as the corresponding fields of the HE capabilities element 600. For example, the element ID 652 can indicate an ID of the EHT capabilities element 650, the length 654 can indicate a length of the EHT capabilities element 650, and the element ID extension 606 can include additional ID information. In at least one embodiment, the EHT MAC capabilities 658 indicate a set of supported EHT MAC features—e.g., information regarding TWT support or triggered TXOP sharing capabilities. In at least one embodiment, the supported EHT-MCS and NSS set 662 can indicate a supported combination of EHT-MCS and NSS at different PPDU bandwidths. In at least one embodiment, the EHT PPE thresholds 664 can indicates a nominal packet packing value. In some embodiments, the EHT PHY capabilities information 660 includes a reserved field 666, a support for 320 MHz in 6 GHz field 668, support for 242-tone resource unit (RU) in bandwidth wider than 20 MHz 670, and other fields 672. In at least one embodiment, for support 320 MHz in 6 GHz field 668, the EHT STA can indicate support for 320 MHz in the EHT PHY capabilities 660 field of the EHT capabilities element 650. In at least one embodiment, the EHT capabilities element 650 indicates a super set of the current BSS channel width in operations elements.

In at least one embodiment, the HE capabilities element 600 and EHT capabilities element 650 are a “per link indication”. In such embodiments, the HE capabilities element 600 and EHT capabilities element 650 can be carried in an association/reassociation request fame sent by a non-AP STA, be present in a probe request frame sent by a non-AP STA, or be present in a tunneled direct link setup (TDLS) discovery request/response frame sent by a non-AP STA. In some embodiments, the HE capabilities element 600 and EHT capabilities element 650 can be carried in a beacon frame transmitted by the AP, be carried in an association/reassociation response frame transmitted by the AP, or carried in a probe response frame transmitted by the AP.

In one embodiment, Table 1 can indicate supported channel widths and maximum supported channel widths for various operating bands. In some embodiments, Table 1 illustrates information for a non-AP EHT STA—e.g., the settings indicated with “*” in Table 1 may not be used by an EHT AP.

TABLE 1

| | | | Supported channel | Supported | Support for |
|---|---|---|---|---|---|
| | | | width set and | Channel | 320 MHz in |
| | | | extended NSS BW | Width set | 6 GHz |
| | Maximum | Supported Channel | support subfields | subfield in | subfield in |
| | supported | Width Set subfield | in VHT | the HE | EHT |
| Operating | channel | in HT capabilities | capabilities | capabilities | Capabilities |
| Band | width | element | element | element | element |
| 2.4 GHz | 20 MHz | 0 | N/A | Set B0 to 0 | 0 |
| | | | | B1 to 0 | |
| | | | | B2 to 0 | |
| | | | | B3 to 0 | |
| 2.4 GHz | 40 MHz | 1 | N/A | Set B0 to 1 | 0 |
| | | | | B1 to 0 | |
| | | | | B2 to 0 | |
| | | | | B3 to 0 | |
| 5 GHz | 20 MHz* | 0 | Set to indicate | Set B0 to 0 | 0 |
| | | | support for up to | B1 to 0 | |
| | | | 80 MHz | B2 to 0 | |
| | | | | B3 to 0 | |
| 5 GHz | 80 MHz | 1 | Set to indicate | Set B0 to 0 | 0 |
| | | | support for up to | B1 to 1 | |
| | | | 80 MHz | B2 to 0 | |
| | | | | B3 to 0 | |
| 5 GHz | 160 MHz | 1 | Set to indicate | Set B0 to 0 | 0 |
| | | | support for up to | B1 to 1 | |
| | | | 160 MHz or | B2 to 1 | |
| | | | 80 + 80 MHz | B3 to 0 | |
| 6 GHz | 20 MHz* | N/A | N/A | Set B0 to 0 | 0 |
| | | | | B1 to 0 | |
| | | | | B2 to 0 | |
| | | | | B3 to 0 | |
| 6 GHz | 80 MHz | N/A | N/A | Set B0 to 0 | 0 |
| | | | | B1 to 1 | |
| | | | | B2 to 0 | |
| | | | | B3 to 0 | |
| 6 GHz | 160 MHz | N/A | N/A | Set B0 to 0 | 0 |
| | | | | B1 to 1 | |
| | | | | B2 to 1 | |
| | | | | B3 to 0 | |
| 6 GHz | 320 MHz | N/A | N/A | Set B0 to 0 | 1 |
| | | | | B1 to 1 | |
| | | | | B2 to 1 | |
| | | | | B3 to 0 | |

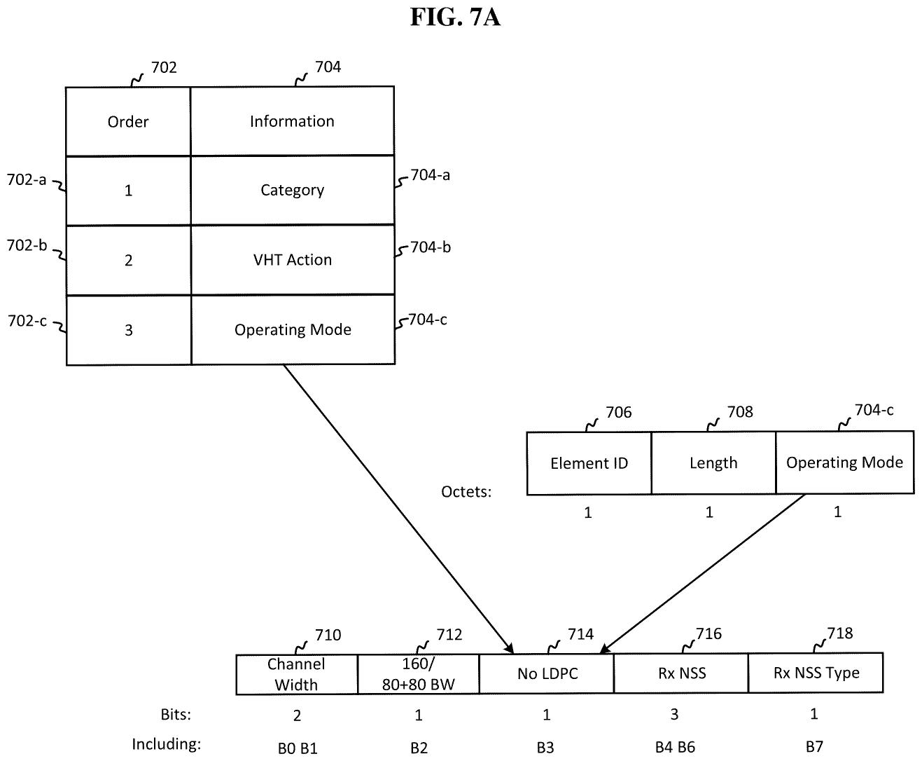

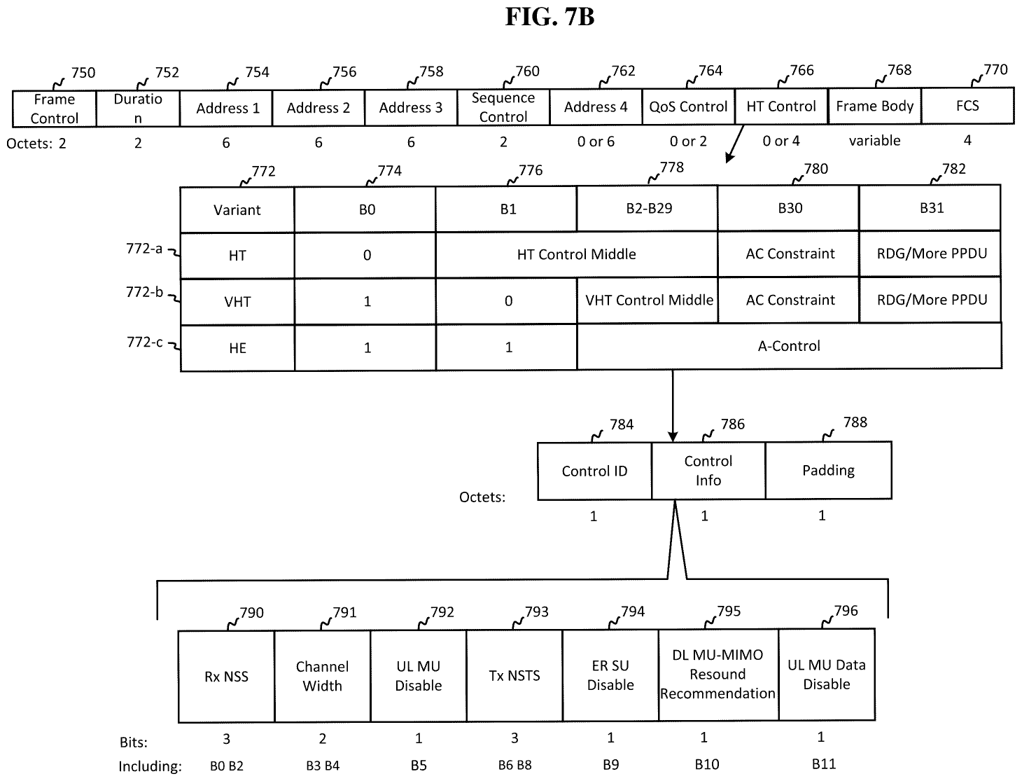

Referring to FIGS. 7A and 7B, in some embodiments, the AP (e.g., or STA) can provide power saving mechanisms while operating in an awake state via an “operating mode change.” In some examples, an STA can change its operating channel width (CW) and/or a maximum number of spatial streams (NSS) that it can support via the operating mode change. Accordingly, power is saved by reducing channel width or the maximum number of NSS. In at least one embodiment, an AP can change its operating mode (e.g., change it receiving (RX) operating mode) by either transmitting an operating mode notification frame (e.g., in a very high throughput (VHT) action frame), transmitting an operating mode notification element within a beacon frame, a reassociation, and/or an association request/response frames, or by transmitting an operating mode (OM) control subfield or an EHT OM control subfield in an A-control field of a quality of service (QoS) data, QoS null, or a class three management frame. In one embodiment, an operating mode notification frame is described with reference to FIG. 7A and an operating mode control subfield is described with reference to FIG. 7B.

For example, the operating mode notification frame format can include information regarding an operating mode. In one embodiment, an order 702 can indicate which information 704 is included. For example, an order 702-a ‘1’ can indicate a category 704-a, an order 702-b ‘2’ can indicate a VHT action 704-b, and a ‘3’ can indicate an operating mode 704-c.

In at least one embodiment, an operating mode notification element can include an element ID 706 that identifies the element, a length 708 that indicate the length of the operating mode notification element, and an operating mode 705-c.

In some embodiments, the operating mode is carried in a non-S1G PPDU (e.g., a PPDU that does not adhere to a sub-1 GHz format) operating mode field. In such embodiments, the operating mode field can include a channel width, a 160 MHz/80+80 MHz BW 712, a no low density parity check (LDPC) 714, a reception (Rx) NSS 716, and a reception (Rx) NSS type 718. In at least one embodiment, the 160 MHz/80+80 MHz BW 712 can indicate support for 80+80 MHz or 160 MHz. In at least one embodiment, the no LDPC 714 can indicate if LDPC is enabled or not. In at least one embodiment, information contained in the channel width 710, the Rx NSS 716, and Rx NSS type 718 can illustrated by the following Table 2:

TABLE 2

| Subfield | Description |
|---|---|
| Channel Width | If the Rx NSS type subfield is 0, indicate the supported channel width: |
| | In VHT STA, see Table 9-81 |
| | In a Television Very High Throughput (TVHT) STA: |
| | Set to 0 for TVHT_W |
| | Set to 1 for TVHT_2W and TVHT_W + W |
| | Set to 2 for TVHT_2W + 2W |
| | The value 3 is reserved |
| Rx NSS | If the Rx NSS Type subfield is 0, this field, combined with other information |
| | described in 9.4.157.3, indicates the maximum number of spatial streams |
| | that the STA can receive. |
| | If the Rx NSS Type subfield is 1, this field indicates the maximum number |
| | of spatial streams that the STA can receive as a beamformee in a single user |
| | (SU) PPDU using a beamforming steering matrix derived from a VHT |
| | Compressed Beamforming report with Feedback Type subfield indicating |
| | MU in the corresponding VHT Compressed Beamforming frame sent by the |
| | STA. |
| | In a non-S1G STA: |
| | Set to 0 for NSS = 1 |
| | Set to 1 for NSS = 2 |
| | . . . |
| | Set to 7 for NSS = 8 |
| Rx NSS type | Set to 0 to indicate that the Rx NSS subfield carries the maximum number of |
| | spatial streams that the STA can receive in any PPDU. |
| | Set to 1 to indicate that the Rx NSS subfield carries the maximum number of |
| | spatial streams that the STA can receive as a beamformee in an SU PPDU |
| | using a beamforming steering matrix derived from a VHT Compressed |
| | Beamforming report with the Feedback Type subfield indicating MU in the |
| | corresponding VHT Compressed Beamforming frame sent by the STA |
| | Note-An AP always sets this field to 0. |

Referring to FIG. 7B, an operating mode control format can include a frame control 750, a duration 752, an address 1 754, an address 2 756, an address 3 758, a sequence control 760, an address 4 762, a quality of service (QoS) 764, a HT control 766, a frame body 768, and an FCS 770. In at least one embodiment, the frame control 750 can indicate the frame (e.g., indicate it is a QoS data frame or management frame). In some embodiments, the duration 752 can indicate a duration of TXOP remaining. In some embodiments, the address 1 754, the address 2 756, the address 3 758, and the address 4 762 can indicate one or more addresses. In some examples, the sequence control 760 can indicate a calibration sequence or calibration position. In some examples, the QoS control 764 can indicate QoS parameters associated with the frame. In at least one embodiment, the frame body 768 can include specific information for the HT control frame, and the FCS 770 can indicate a frame check sequence for the frame. In at least one embodiment, the HT control 766 can include information based on a variant 772 of the frame. For example, the HT control 766 can indicate a HT variant 772-a, a VHT variant 772-b, and a HE variant 772-c. In one embodiment, for each variant 772, FIG. 7B can illustrate values for one or more bits in the HT control 766. For example, when it is the HT variant 772-a, the HT control 766 can include bit B0 774 having a value zero ‘0,’ bits B1-29 can indicate HT control middle, bit B30 can indicate an AC constraint and whether a mapped AC of an RD (reverse direction) data frame is constrained to a single AC. In some embodiments, bit B31 782 can indicate when using RD protocol, a STA having obtained TXOP granting other STAs an opportunity to transmit data back within the same TXOP. In other embodiments, for variant VHT 772-b, the HT control 766 can include bit B0 774 having a value ‘1,’ bit B1 776 having a value ‘0’, bits B2-29 778 can have a value associated with the VHT control middle, bit B30 780 can indicate the AC constraint, and bits B31 782 can indicate the reverse direction grant (RDG) or additional PPDUs. In other embodiments, for variant HE 772-c, the HT control 766 can include bit B0 774 having a value ‘1,’ bit B1 776 having a value ‘0’, and bits B2-29 778, bit B30 780, and bits B31 782 can indicate the A-control field format. In one embodiment, the A-control field can include a control ID 784, a control information 786, and padding 788. In at least one embodiment, the control ID 784 field can include information indicated in Table 3 as shown:

TABLE 3

| | | Length of the control | |
|---|---|---|---|
| | | information subfield | Content of the Control |
| Control ID value | Meaning | (bits) | Information subfield |
| 0 | Triggered response | 26 | See 9.2.4.6a.1 (TRS |
| | scheduling (TRS) | | control) |
| 1 | Operating Mode | 12 | See 9.2.4.6a.2 (OM |
| | (OM) | | control) |
| 2 | HE link adaptation | 26 | See 9.2.4.6a.3 (HLA |
| | (HLA) | | control) |
| 3 | Buffer Status Report | 26 | See 9.2.4.6a.4 (BSR |
| | (BSR) | | control) |
| 4 | Uplink (UL) power | 8 | See 9.2.4.6a.5 (UPH |
| | headroom (UPH) | | control) |
| 5 | Bandwidth query | 10 | See 9.2.4.6a.6 (BQR |
| | report (BQR) | | control) |
| 6 | Command and status | 8 | See 9.2.4.6a.7 (CAS |
| | (CAS) | | control) |
| 7 | EHT operating mode | 6 | See 9.2.4.7.8 (EHT |
| | (EHT OM) | | OM control) |
| 8 | Single response | 10 | See 9.2.4.7.9 (SRS |
| | scheduling (SRS) | | control) |
| 9 | AP assistance request | 20 | See 9.2.4.7.10 (AAR |
| | (AAR) | | control) |
| 10-14 | Reserved | | |
| 15 | Ones need expansion | 26 | Set to all 1s |
| | surely (ONES) | | |

In at least one embodiment, control information 786 can include Rx NSS 790, channel width 791, UL multi-user (MU) disable 792, Tx number of total space time streams (NSTS) 793, extended range (ER) SU disable 794, downlink (DL) MU-MIMO resound recommendation 795 and UL MU data disable 796. In at least one embodiment, Rx NSS 790 can indicate the reception number of spatial streams. In one embodiment, channel width 791 can indicate the operating bandwidth. In some embodiments, the channel width 791 can indicate the reduced channel bandwidth for the operating mode change. In at least one embodiment, the UL MU disable indicates whether uplink multi-user is enabled or disabled. In some embodiments, the Tx NSTS 793 indicates a number of total space time streams (NSTS) for the transmission. In one embodiment, ER SU disable 794 can indicate whether the extended single range user function is enabled or disabled. In some embodiments, the DL MU-MIMO resound recommendation 795 can include information regarding a resound. In one embodiment, the UL MU data disable 796 can indicate whether the UL MU data feature is enabled or disabled.

In addition to the operating mode change, several new features that may depend on the BSS bandwidth are being discussed for IEEE 802.11bn. For example, a feature being discussed is non-primary channel access (NPCA). As discussed above, for baseline operations, an AP or an associated non-AP STA can transmit on any non-primary channel within the BSS bandwidth only if it also transmits on a primary 20 MHz channel. In one embodiment, if the primary channel is busy due to overlapping BSS (OBSS), then the AP (or non-AP STA) cannot transmit even if a secondary channel is available and idle. In such embodiments, there can be increased delays to channel access and a reduction in efficiency of channel utilization. To overcome these deficiencies, the NPCA feature is proposed. For example, an AP can enable NPCA operations. In such embodiments, the AP can disclose one or more back-up 20 MHz primary channels. In some embodiments, if an OBSS transmission occupies the primary channel of the AP for a certain Network Allocation Vector (NAV) duration, then the AP and associated non-AP STAs that support NPCA can switch to one of the back-up primary channels for performing frame exchanges—e.g., the AP and associated non-AP STAs can treat the back-up channel as a temporary primary channel till an end of the NAV duration on the main primary channel. During the time of the NPCA, transmission can still be limited to be within the BSS bandwidth. In one embodiment, the AP and non-AP STAs can return to the primary channel at the end of the NAV duration.

In other embodiments, another feature could be dynamic power save (DPS). In one embodiment, to save AP power consumption and minimize degradation in performance for latency sensitive traffic, the DPS operation is proposed. In a DPS mode, by default the AP may operate with reduced capabilities—e.g., the AP can reduce one or more supported channel widths, support limited PPDU formats, reduce supported MCS sets, and reduce supported NSS sets. In one embodiment, the AP can operate with the reduced capabilities for reception, for transmission, or for both. By operating with reduced capabilities, the AP can save power. In one example, the reduced channel widths, limited PPDU formats, reduced MCS set, and reduced NSS set can be referred to as ‘reduced operating parameters.’ In at least one embodiment, when the AP receives a request within a TXOP, the AP can increase one or more of its supported bandwidth, supported PPDU formats, MCS set, and NSS set for at least the duration of the TXOP. In one example, the increased bandwidths, supported PPDU formats, and increased MCS and NSS set can be referred to as ‘enhanced operating parameters.’ Accordingly, after sending a request to the AP to increase the capabilities of the AP, an owner of the TXOP can perform communication at the enhanced channel width, PPDU formats, MCS and NSS set values for the rest of the TXOP. In such embodiments, after the TXOP (e.g., or a predetermined time after the TXOP), the AP can return to its reduced operating parameters. In at least one embodiment, STAs that do not support DPS can operate with the AP with the reduced operating parameters. In some embodiments, STAs that do support DPS can operate with the AP with the reduced operating parameters or operate at the AP's enhanced operating parameters after sending a request to the AP to transition. It should be noted that even among a next generation of Wi-Fi devices, some non-AP STAs may not support DPS.

In some embodiments, a feature could be a fine time measurement (FTM). That is, the FTM protocol can enable range estimation and localization with Wi-Fi. In one embodiment, an initiating STA and a responding STA can exchange a sequence of frames to estimate the round trip time (RTT). In at least one embodiment, the protocol can include versions such as enhanced distributed channel access (EDCA) ranging, trigger-based (TB) ranging, non-trigger based ranging, passive ranging, etc. In any version, though, an accuracy of range measurement is limited by the bandwidth of the exchanged frames. Accordingly, additional extensions have been proposed to extend the ranging frames to exploit transmission bandwidths up to 320 MHz for higher accuracy ranging and localization.

In one embodiment, a feature could be fractional frequency reuse (FFR). In one embodiment, channel access delay is minimized between neighboring BSSs by each BSS using or selecting orthogonal operating channels. However, using orthogonal operating channels is inefficient since the same channels cannot be reused by the neighboring BSS. To improve the efficiency, FFR can be used where neighboring APs use a shared common frequency resource to serve STAs that are within a small radius at the AP with a lower transmit power. In at least one embodiment, though, for serving further away STAs, the AP can revert back to using frequency resources that are orthogonal to the resources used by other BSSs. That is, since the common frequency resource is used with a lower power to serve STAs close to the AP, they do not generate significant interference at the neighboring BSS and do not increase the channel access delay at the neighboring BSS but is less effective for further away STAs.

In other embodiments, another feature could be dynamic bandwidth selection (DBS). In one embodiment, for DBS, several neighboring APs can coordinate to temporarily share each other's frequency resources. In some embodiments, the neighboring APs can share the frequency resources for a periodic or a long-term basis. This can enable each AP to transition between a low bandwidth state and a high bandwidth state. In at least one embodiment, after the multi-AP negotiation and the AP's operating bandwidth changes, the AP can notify associated STAs about the shared resources using operating mode change procedures or new procedures. In at least one embodiment, STAs that do not support DBS can operate with the AP at the low bandwidth state. In other embodiments, STAs that do support DBS can operate on the AP's current bandwidth state, which the AP can indicate or update as the current bandwidth state changes. It should be noted that even among next generated non-AP STA Wi-Fi devices, some STAs may not support DBS. In one embodiment, the DBS feature or operation can also be called or referred to as a “dynamic bandwidth expansion” (DBE).

Some of these features (e.g., for DPS, DBS, and FFR) inherently rely on disclosing different applicable bandwidths to different associated STAs. However, current solutions and mechanisms for the BSS operating bandwidth allow only a common bandwidth indication for both uplink and downlink directions. Such mechanism can distinguish clients based only on a physical layer (PHY) version of the respective device. However, multiple STAs that do support or do not support a respective feature can belong to the same PHY version as well—e.g., it may not be currently possible to distinguish between two STAs that support have the same PHY version but where one STA supports a feature and the other STA does not support the feature. In other of these features, a performance of the feature depends on the operating bandwidth of the BSS. For example, for NPCA operations, the wider the bandwidth of the system, the higher a chance is of ensuring that a back-up primary channel (and any corresponding secondary channels) are also not blocked by the OBSS transmission that is blocking the primary 20 MHz channel. That is, a wider bandwidth improves the performance of the NPCA feature. In other embodiments, for FTM, an accuracy of the time stamp estimation is fundamentally limited by the bandwidth of the frame exchanged. Higher bandwidth for frame exchanges can improve the accuracy of the time stamp estimation. Thus, in enterprise scenarios where an AP can restrict the BSS bandwidth to reduce channel access delay to neighboring APs, it is beneficial to if higher operating bandwidth are utilized for the features. However, a mechanism to allow an AP or an associated STA to violate the bandwidth that is normally used for operating the BSS is not present—e.g., there is no way to go beyond the operating bandwidth of the BSS.

Accordingly, for these features (e . . . g, NPCA, DPS, FTM, FFR, DBS, etc.), it would be beneficial if the AP can restrict or enhance transmission bandwidth to be used for uplink or downlink transmissions for certain features, for all or a subset of associated STAs, for certain types of transmissions, or when certain rules or conditions apply. However, current mechanisms only allow the AP to set the bandwidth at a BSS level. This bandwidth is the same for both uplink and downlink transmissions. Additionally, current mechanism only discriminate STAs based on their PHY version. There is no mechanism for an AP or STA to violate the operating bandwidth set at the BSS level for some features.

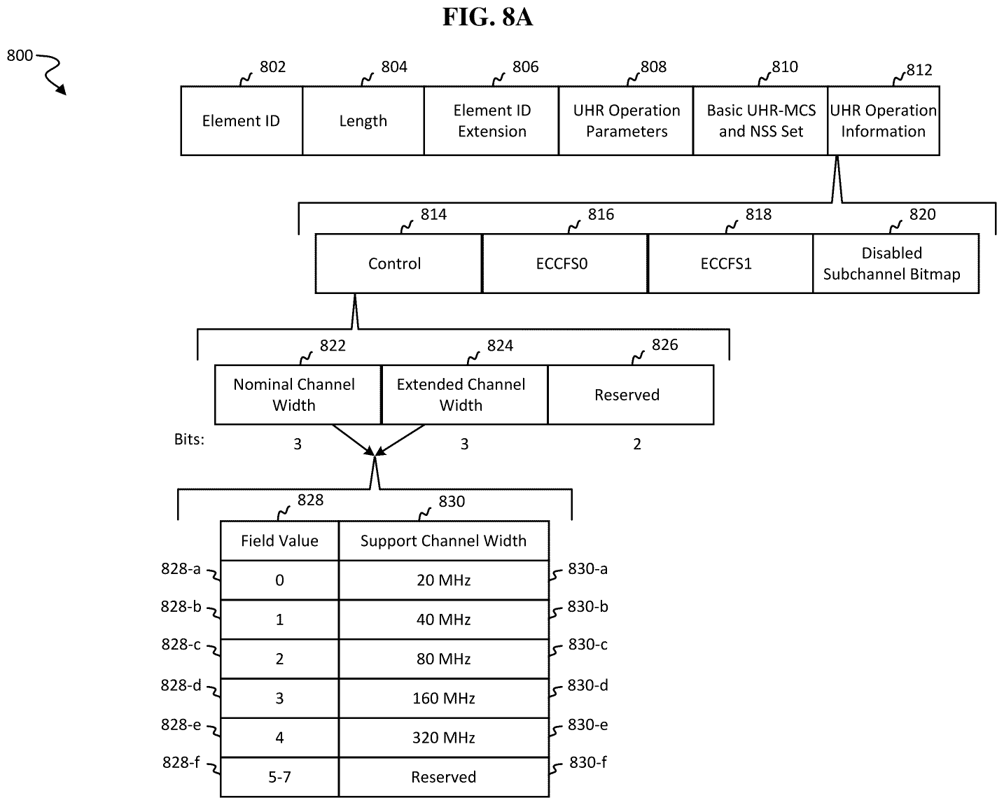

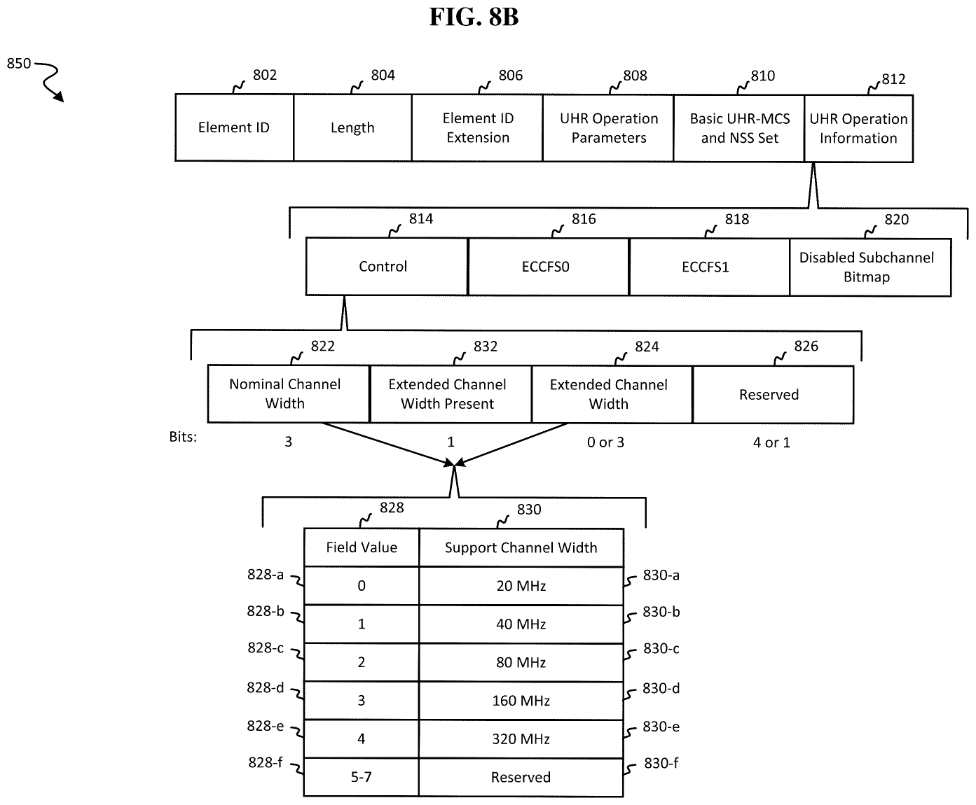

FIGS. 8A and 8B show examples of extended channel width fields in an operation element in accordance with an embodiment herein. The format depicted in FIGS. 8A and 8B are for explanatory and illustration purposes. FIGS. 8A and 8B do not limit the scope of this disclosure to any particular implementation. It should be noted the words bandwidth and channel width are used interchangeably in this disclosure. This should not be construed as a limitation. Additionally, it should be noted that although some of the following embodiments and examples refer to a specific generation of Wi-Fi (e.g., such as ultra high reliability (UHR)), the proposed embodiments can also be applicable for any future Wi-Fi generation as well as for indicating an operating bandwidth for features of that generation. It should be noted that the term BSS bandwidth used in the embodiment can refer to the BSS bandwidth of a specific generation of Wi-Fi devices. For example, the BSS bandwidth can refer to the BSS bandwidth applicable to UHR systems. In some examples, changing a BSS bandwidth for the specific generation of Wi-Fi devices can also change or impact the BSS bandwidth applicable to older generation Wi-Fi devices (e.g., legacy devices). For example, restricting a BSS bandwidth of a UHR device to 80 MHz can imply that the BSS bandwidth for pre-UHR devices is also limited to 80 MHz, subject to any additional maximum bandwidth restrictions corresponding to the respective Wi-Fi generation. The generation specific BSS bandwidths for the HT, VHT, HE, and EHT generations can be indicated in the HT operation element, VHT operation element, HE operation element, and EHT operation element, respectively, transmitted by the AP. In at least one embodiment, FIG. 8A illustrates a first example of an extended channel width field in a UHR operating element 800 and FIG. 8B illustrates a second example of an extended channel width field in a UHR operating parameter 850.

In at least one or more embodiments, in order to minimize a channel access delay for neighboring basic service sets (BSSs), to save power, or for other purposes, an access point (AP) can intend to restrict a normal (e.g., nominal) bandwidth of operation assigned for devices within its BSS for uplink and downlink transmission. In some embodiments, though, this can cause an AP to restrict its bandwidth to a bandwidth lower than its maximum bandwidth—e.g., the AP can end up using restricting itself even though it capable of operating on wider bandwidths. For example, in an enterprise network or when an AP intends to save power, the AP can set its BSS bandwidth corresponding to one or more Wi-Fi generations to 80 megahertz (MHz) even if the AP is capable of operating on a wider bandwidth. In other examples, however, the AP can for specific stations (STAs), for specific transmissions, or under specific conditions, intend to allow devices in its BSS, and belonging to those Wi-Fi generations, to use either a wider or narrower bandwidth than the nominal bandwidth—e.g., the AP can intend to increase or decrease the bandwidth for certain STAs, transmissions, or specific conditions. For example, during a non-primary channel access (NPCA) mode, when a primary channel of the AP is busy due to an overlapping BSS (OBSS) transmission, the AP may intend to allow NPCA enabled UHR devices in its BSS to perform channel access on secondary channels for the duration of the OBSS transmission. In such embodiments, the AP can define a backup primary channel for contention. In some embodiments, the backup primary channel and/or some of the secondary channels can be outside the normal operation bandwidth of the BSS applicable to the UHR devices. Additional conditions can also still be applied on a traffic identifier or access category of these transmissions. In some embodiments, a normal operating bandwidth can still apply for transmissions that occur when the primary channel is idle (e.g., detected as idle by the AP and/or the transmitting UHR devices).

In other examples, while an AP is operating in a dynamic power save (DPS) mode, the AP can allow STAs that support DPS operation to initiate transmissions with the AP on a wider bandwidth. For example, the STA can initiate a transmission to the AP that utilizes the wider bandwidth with an initial control frame. In at least one embodiment, parts of the wider bandwidth can lie outside the normal operating bandwidth indicated by the AP for devices in the BSS. In at least one embodiment, the normal bandwidth can apply for devices that do not support the DPS—e.g., the normal bandwidth can still apply for other UHR STAs that do not support DPS operations.

In some embodiments, when an AP or UHR STA are performing a fine time measurement (FTM), an AP can allow an STA to perform the FTM frame exchange at a wider bandwidth than the normal operating bandwidth of the AP applicable to devices in the BSS for increased accuracy for ranging. In such embodiments, the normal operating bandwidth can still apply for other transmissions initiated by the STA—e.g., by the UHR STA.

In at least one embodiment, when an AP is utilizing a fractional frequency reuse (FFR) operation, the AP can enable STAs (e.g., UHR STAs) that are in close vicinity to the AP to optionally transmit at a wider bandwidth than the normal operation bandwidth of the AP applicable to devices in the BSS. In at least one embodiment, the AP can determine the STAs that are close in vicinity to the AP, based on the received power or relative signal strength indicator (RSSI) observed at the STAs or received from those STAs being above a predefined threshold.

In some embodiments, for increasing or decreasing its operating bandwidth for the above features, the AP can perform a multi-AP coordination or negotiation. For example, as described above, an AP can select its nominal bandwidth (e.g., applicable to one or more Wi-Fi generations, such as UHR) to allow sufficient orthogonal channels for its neighboring BSS. Due to OBSS though, an AP (e.g., or its associated STA) using the extended bandwidth for transmission for a certain feature/criterion can overlap with a neighboring AP's primary channel, thus causing channel access delay. In an embodiment described herein, a first AP that intends to utilize extended bandwidth transmissions, can initiate a multi-AP coordination request to a second neighboring AP whose operating bandwidth overlaps with the extended bandwidth of the first AP. In at least one embodiment, the first AP can transmit a request frame to either request permission to use the extended bandwidth for a feature at an arbitrary or specific time or to request the second AP avoid using certain channels for transmission (e.g., for a time or permanently). In embodiments where the first AP is requesting permission to use the extended bandwidth, the first AP can transmit a request frame that indicates the 20 MHz channels that the first AP intends to use for the extended bandwidth transmissions, an indication of time of use or statistics of use of the extended bandwidth by the first AP. In embodiments where the first AP requests the second AP refrain from using the certain channels, the AP can transmit a request frame that indicates the 20 MHz channels that the first AP request the second AP to not use and/or an indication of a time window or time duration during which the request is applicable—e.g., the request frame can indicate how long the first AP is requesting the second AP refrain from using the specified channels. In at least one embodiment, the second AP can respond to the request frame with a response frame. In some embodiments, the second AP transits the response frame to indicate whether it allows or disallows the first AP's use of the extended bandwidth. In other embodiments, the second AP transmits the response frame to indicate whether it will refrain from using certain channels for transmission—e.g., the second AP can indicate whether it will accept the request from the first AP to avoid using certain channels. In at least one embodiment, in addition to the rejection, the second AP can also recommend alternative extended bandwidths, other parameters that can be used by the first AP for the feature, and/or alternative time durations during which the second AP allows the first AP to use the extended bandwidth. In some embodiments, negotiations for the multi-AP coordination can be performed by exchanging a bandwidth coordination request frame and bandwidth coordination response frame between two APs. In such embodiments, the frame exchange can be part of a common framework for coordination between two or more APs.

In at least one embodiment, referring to FIG. 8A, a UHR operation element 800 can have an extended channel width field in order to signal the extended bandwidth described herein. In at least one embodiment, the UHR operation element 800 can include an element identification (ID) 802, a length 804, an element ID extension 806, UHR operating parameters 808, basic UHR-MCS and NSS set 810, and UHR operating information 812. In at least one embodiment, the element ID 802 (e.g., and element ID extension 806) can identify the UHR operation element 800. In one embodiment, the length 804 can indicate the length of the UHR operation element 800. In at least one embodiment, the UHR operation parameters 808 can indicate parameters associated with a UHR operation in the UHR operation element 800. For example, the UHR operation parameters 808 could indicate parameters for a feature (e.g., DPS, NPCA, FTM, FFR, DBS, etc.). In other embodiments, the UHR operation parameters 808 could indicate if a respective feature is enabled or disabled (e.g., whether DPS, NPCA, FTM, FFR, or DBS is enabled or disabled). In at least one embodiment, the basic UHR-MCS and NSS set 810 can indicate the MCS set and NSS set supported by the device. In one or more embodiments, the UHR operations information 812 can include a control 814, an ECCFS0 816, an ECCFS1 818, and a disabled subchannel bitmap 820. In at least one embodiment, the control 814 can include a nominal channel width 822, an extended channel width 824, and a reserved field 826.

In at least one embodiment, the nominal channel width 822 can indicate a nominal (e.g., normal) bandwidth for operation within a BSS. In at least one embodiment, the AP supports the nominal bandwidth for normal operations with its associated STAs unless some specific conditions are satisfied and/or the associated STAs satisfy some specific feature. In at least one embodiment, the nominal channel width 822 can be the same for uplink transmissions and downlink transmission. In other embodiments, the nominal channel width 822 can be different for uplink and downlink transmission. In at least one embodiment, the nominal channel width 822 is applicable to devices of one or more Wi-Fi generations.

In one or more embodiments, the extended channel width 824 can indicate a largest (e.g., maximum) of the extended bandwidths supported by the AP for its associated STAs across the different criteria and features—e.g., the extended channel width 824 indicates a maximum bandwidth supported by the AP. In some embodiments, the extended channel bandwidth indicated in the estimated channel width 824 is applicable to devices of one or more Wi-Fi generations. In some examples, a specific operating bandwidth for a feature (e.g., for NPCA, DPS, FTM, FFR, etc.) can be indicated in a separate information element corresponding to that feature—e.g., within a second frame associated with one of the features. In some embodiments, the extended channel width 824 indicated is for both uplink and downlink directions. In other embodiments, the extended channel width 824 is different both the uplink and downlink directions. In at least one embodiment, the extended channel width 824 value can be limited by a maximum supported bandwidth indicated by the AP in the AP capabilities element for each applicable Wi-Fi generation. In other embodiments, the extended channel width 824 value is not limited by the maximum supported bandwidth indicated by the AP in its capabilities element. In some embodiments, the indication of the extended bandwidth of operation is optional. In such embodiments, there can be an additional field indicating a presence or absence of the extended bandwidth indication (e.g., indicate the presence or absence of the extended channel width 824).

In some examples, the UHR operation element 800 can include an indication of the extended bandwidth central frequencies. For example, the UHR operation element 812 can include an extended channel center frequency segment 0 (ECCFS0) 816 and an extended channel center frequency segment 1 (ECCFS1). In at least one embodiment, the ECCFS0 816 and ECCFS1 818 indicate a center frequency of the extended bandwidth of operation for the BSS. In at least one embodiment, if the extended bandwidth is not contiguous, a center frequency of the primary and center frequency of the secondary segments can be indicated separately.

In at least one embodiment, the UHR operations information 812 can also include a reduced bandwidth of operation. That is, in some embodiments, the AP can reduce the bandwidth. For example, the AP can utilize the reduced bandwidth to indicate a reduced bandwidth that can be used by one or more features within the BSS. In at least one embodiment, the reduced bandwidth is applicable for devices of one or more Wi-Fi generations.

In at least one embodiment, the above mentioned signaling can be included in a beacon frame, a probe response frame, or an association (e.g., or reassociation) response frame. In at least one embodiment, it is included within the UHR operations element 800 as described herein. In some embodiments, the signaling is present in an extended channel element or in a new element. In at least one embodiment, the extended (e.g., or reduced) bandwidth indications are specific for a Wi-Fi generation. In other embodiments, the extended (e.g. or reduced) bandwidth indications are specific for multiple Wi-Fi generations. In at least one embodiment, the extended bandwidth indication 824 and nominal channel width 822 can be used by unassociated STAs in determining whether to perform an association with an AP. In some embodiments, the nominal channel width 822 and extended channel width 824 are used by a neighbor AP to perform channel frequency selection. In some embodiments, an associated STA of an applicable Wi-Fi generation operates as per the nominal channel width 822 indicated by the AP unless it meets some additional criteria. In such embodiments, the AP can provide an applicable bandwidth for the additional criteria to the associated STA. In one embodiment, the basic UHR-MCS and NSS set 810 (e.g., the MCS and NSS set for a respective capabilities element) can carry an indication of the supported MCS and NSS combinations for all bandwidths up to the extended channel width 824. In other embodiments, the UHR-MCS and NSS set 810 for the extended channel width 824 can be indicated separately in a different element transmitted by the AP.

In at least one embodiment, when the indications are carried in the UHR operations element (as illustrated in FIG. 8A), the nominal channel width 822 and the extended channel width 824 fields can have a size of three (3) bits. In one embodiment, the extended channel width 824 can indicate the largest of the extended bandwidths supported by the AP across the different criterions or features. In one embodiment, the nominal channel width 822 or the extended channel width 824 can have a field value 828 that corresponds to a supported channel width 830. For example, the nominal channel width 822 or the extended channel width 824 can be set to a value 828-a zero ‘0’ to indicate a supported channel 20 MHz 830-a, set to a value 828-b zero ‘1’ to indicate a supported channel 40 MHz 830-b, set to a value 828-c two ‘2 to indicate a supported channel 80 MHz 830-c, set to a value 828-d three ‘3’ to indicate a supported channel 160 MHz 830-d, set to a value 828-e four ‘4’ to indicate a supported channel 320 MHz 830-e, or set to a value 828-f between five and seven ‘5-7’ indicating a supported channel beyond 320 MHz—e.g., the values 5-7 can currently be reserved and can indicate future supported channel widths 830. In at least one embodiment, the indicated bandwidths in the nominal channel width 822 and extended channel width 824 can be applicable for UHR STAs.

In some embodiments, the UHR operation element 800 includes the new 8-bit extended channel center frequency segment 0 (ECCFS0) field 816 to indicate a center frequency of a primary contiguous segment of the extended channel width 824. In at least one embodiment, the ECCFS1 field 818 is an 8-bit field that indicates a center frequency of a secondary contiguous segment of the extended channel width 824. In some embodiments, the extended channel width 824 and the ECCFS0 816 and ECCFS1 818 can be carried in a new extended channel width element. In at least one embodiment, the channel center frequency segment 0 (CCFS0) or channel center frequency segment 1 (CCFS1) fields of the UHR operations element 800 can indicate the extended bandwidth central frequency when the extended channel width 824 is present. In at least one embodiment, when the extended channel width 824 is not present, the CCFS0 and CCFS1 subfields can indicate the nominal bandwidth central frequency.

Referring to FIG. 8B, in some embodiments, the extended channel width 824 is optionally present. In such embodiments, a UHR operation element 850 can include an extended channel width present subfield 832. The extended channel width present 832 subfield indicates whether the extended channel width 824 is present. In at least one embodiment, the UHR operation element 850 is otherwise equivalent with UHR operation element 800. That is, UHR operation element 850 also includes the element ID 802, length 804, element ID extension 806, UHR operations parameters 808, basic UHR-MCS and NSS set 810, and UHR operation information 812. It should be noted that the formats depicted in FIGS. 8A and 8B are for illustration purposes only, other formats are possible. For example, in some embodiments, the extended channel width 824 is carried outside the control 814 of the UHR operations element 800 or 850. In other embodiments, the nominal channel width 822 can be optional. In such embodiments, the UHR operations element 850 can include a nominal channel width present subfield indicating whether the nominal bandwidth is present. In other embodiments, the nominal channel width is not explicitly indicated. In such embodiments, the nominal channel width applicable to UHR transmission can be the same as a channel width indicated in the channel width field of one or more of the pre-UHR operation elements transmitted by the AP. In at least one embodiment, when multiple pre-UHR operations elements are present, an order of precedence of the present elements in order to determine the nominal bandwidth can be as follows: EHT>HE>VHT>HT. Accordingly, if all previous generation operation elements are present (e.g., an EHT, HE, VHT, and/or HT operations element), then the nominal operating bandwidth for UHR transmission can be the same as the value indicated in the channel width field of the EHT operation element.

In some embodiments, the operation element 800 or operation element 850 can contain a single channel width field that can indicate a maximum bandwidth used for at least some features and for normal operations. In such embodiments, the CCFS0 and CCFS1 can indicate the center frequency of the indicated bandwidth.

In at least one embodiment, either operation element 800 or operation element 850 can include a reduced channel width field indicating a reduced bandwidth used by one or more features.

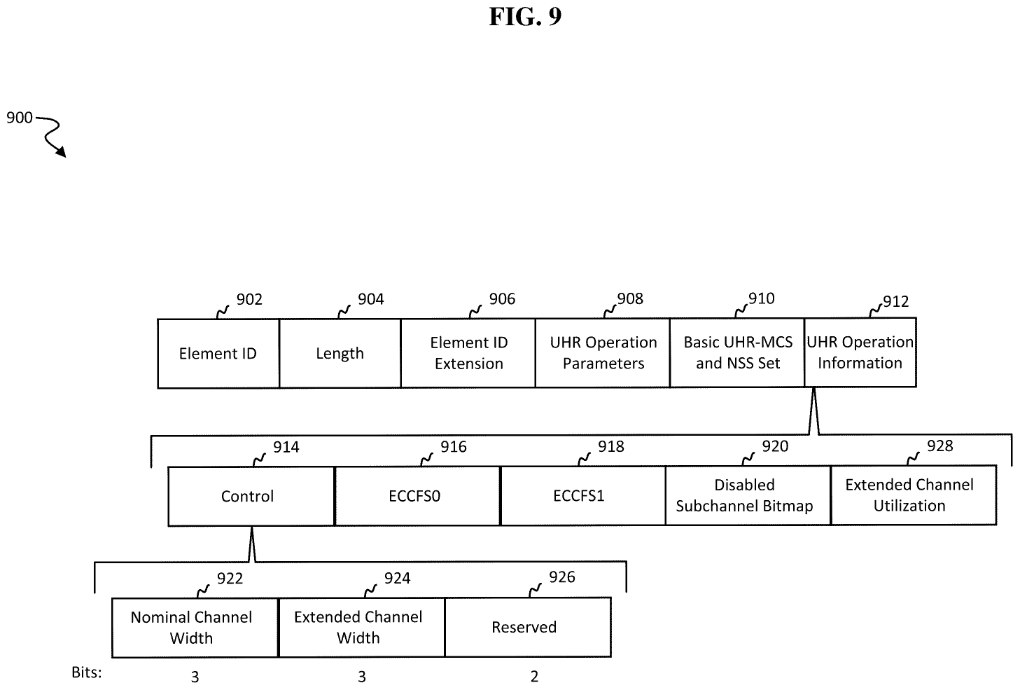

FIG. 9 illustrates an example of an operation element 900 with an indication of an extended channel utilization statistic. The format depicted in FIG. 9 is for explanatory and illustration purposes. FIG. 9 does not limit the scope of this disclosure to any particular implementation. In at least one embodiment, the operation element 900 is an example of a UHR operation element. In one embodiment, the operation element 900 includes fields similar to or the same as operation element 800 or operation element 850 as described with reference to FIGS. 8A and 8B. For example, the operation element 900 can include an element ID 902, a length 904, an element ID extension 906, UHR operating parameters 908, and basic UHR-MCS and NSS set 910. In some embodiments, the fields can be examples of element ID 802, length 804, element ID extension 806, UHR operating parameters 808, and basic UHR-MCS and NSS SET 810 as described with reference to FIGS. 8A and 8B, respectively.

In at least one embodiment, the operations element 900 also includes UHR operation information 912. In one embodiment, the UHR operation information 912 can include a control 914 (e.g., a control field with a nominal channel width 922, an extended channel width 924, and a reserved field 926), an extended channel center frequency segment 0 (ECCFS0), ECCFS1 918, a disabled subchannel bitmap 920, and an extended channel utilization 928.

In at least one embodiment, an AP can provide an indication of one or more statistics of air-time usage of a nominal bandwidth, an extended bandwidth, or both, within the AP's basic service set (BSS). In one or more embodiments, the statistics information is computed based on statistics from past “A” beacon intervals, where “A” is a predefined number according to the IEEE family of standards or configured and reported by the AP.

In some embodiments, the statistics can include an indication of a fraction of airtime used for transmission that utilize the extended channel width 924 by the device of the BSS. In one embodiment, the indication is from 0 to 255, with 255 representing 100% of the airtime used for the extended channel width 924. In some embodiments, a denominator of a fraction value associated with the statistic is a total time of measurement (e.g., ‘A’ beacon intervals). In other embodiments, the denominator is the total airtime within the total measurement time that is occupied by all transmission of the BSS.

In some examples, the statistics can include an indication of a fraction of airtime used for transmissions that are eligible to use the extended channel bandwidth 924. That is, even if the extended channel bandwidth is not used (e.g., due to the extended channel being busy for example), the transmission time is still included in the computation if the extended channel was eligible for use. In one embodiment, the indication can be from 0 to 255, where 255 indicates 100% of the airtime was used for transmissions that are eligible to use the extended bandwidth 924. In some embodiments, a denominator of a fraction representing the statistic is the total time of measurement (e.g., ‘A’ beacon intervals). In other embodiments, the denominator is total airtime within the total measurement time that is occupied by all transmission of the BSS.

In at least one embodiment, the statistics can include an indication of a fraction of airtime used for transmissions corresponding to the nominal channel width 922 used by devices of the BSS. In at least one embodiment, the indication can be from 0 to 255, where 255 indicates 100% of the airtime was used for transmission that are eligible to use the nominal bandwidth 922. In some embodiments, a denominator of a fraction representing the statistic is the total time of measurement (e.g., ‘A’ beacon intervals).

In one example, the statistics can include an indication of a channel utilization of the nominal channel width 922. In at least one embodiment, the encoding of the channel utilization of the nominal channel width can be similar to the channel utilization field of the BSS load element. In at least one embodiment, the statistics can include a channel utilization of the different sub-bands of the extended channel width element.

In at least one embodiment, the statistics mentioned with reference to FIG. 9 can be included in the extended channel utilization 928. In other embodiments, the statistics can be carried in a separate element (e.g., within the UHR BSS load element or UHR extended BSS load element), in a new element, or in an extended channel width 924. In at least one embodiment, the statistics described herein can be included in a beacon frame, probe response frame, or an association (e.g., reassociation) response frame transmitted by the AP. In at least one embodiment, the indicated bandwidths (e.g., or statistics) are applicable to UHR STAs. In one or more embodiments, a neighboring AP (e.g., neighboring UHR AP) can utilize the nominal bandwidth, extended bandwidth, and the nominal and extended bandwidth usage statistics to perform channel selection for its BSS. In at least one embodiment, a non-AP STA (e.g., a UHR non-AP STA) can perform roaming using the nominal bandwidth, the extended bandwidth, and the extended bandwidth usage statistics reported by the AP to make roaming decisions.

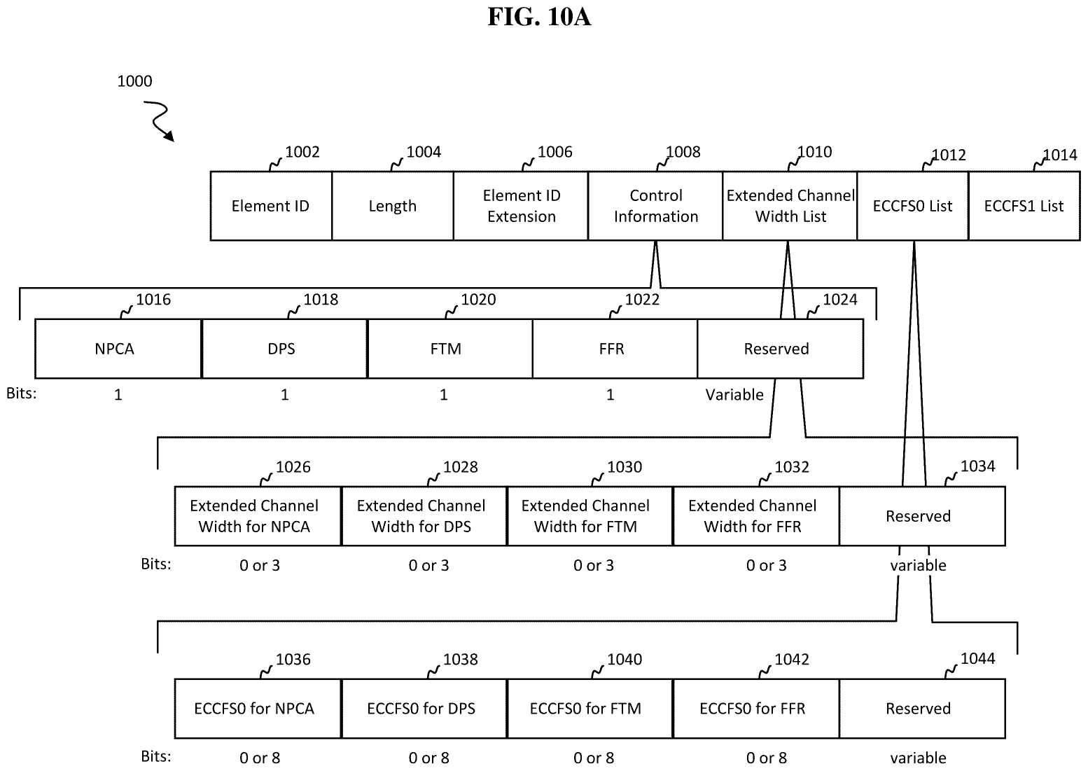

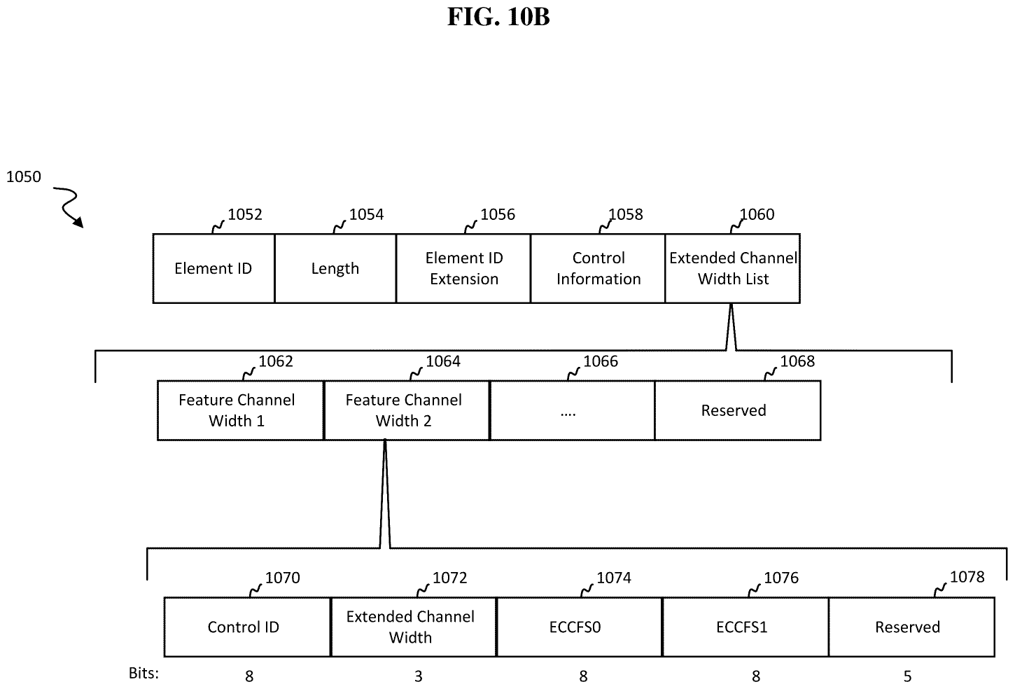

Referring to FIGS. 10-14, in some examples, the AP can also indicate bandwidths (e.g., nominal and extended bandwidths) for each applicable feature. In such embodiments, the AP can indicate the bandwidths using broadcast or unicast signaling for each of the features. For example, the AP can indicate a non-nominal bandwidth of operation applicable for a respective feature or criterion. In such examples, there can be a field in the extended channel width or the UHR operations element or the aforementioned broadcast or unicast signaling for the feature, that indicates if an extend channel width (e.g., extended channel width 824) is applicable for the given feature or criterion. In some embodiments, the AP can further indicate a channel center frequency (CCF) corresponding to the primary contiguous segment of the non-nominal bandwidth applicable to the feature as well as the channel center frequency (CCF) corresponding to the secondary contiguous segment of the non-nominal bandwidth applicable to the feature. In at least one embodiment, the AP can also indicate a component of the 20 MHz channels of the bandwidth that are disallowed for use and need to be punctured. In some embodiments, the AP can also indicate one or more potentially non-contiguous subchannels that are applicable for use for transmission for the feature. In some examples, the AP can include an indication of the MCS and NSS combinations that are applicable for the extended bandwidth supported by the feature. In some embodiments, the AP can also include an indication of the associated STAs that are eligible to use the applicable non-nominal bandwidth supported by the feature/criterion. In such embodiments, the associated STAs indication can be carried in an association identification (AID) bitmap element. In some examples, the AP can also indicate a specific Wi-Fi generation of devices that are eligible to use the non-nominal bandwidth. In at least one embodiment, the AP can also indicate a type of traffic that is eligible to use the non-nominal bandwidth applicable for the feature/criterion. For example, if the eligibility is indicated by a traffic identifier (TID), the indication can be included in the TID bitmap. In other examples, if the eligibility is by access category (AC), then the indication can be carried in the AC bitmap. In some embodiments, the indication can also clarify if the eligibility is for uplink, downlink and triggered uplink, or for both traffic types. In some embodiments, the signaling can be included in a beacon frame, a probe response frame, or association (reassociation) response frame. In such embodiments, the indication can be included in an element (e.g., UHR operation element, an extended channel width element, or a new element). In at least one embodiment, the features described herein can include at least one of a NPCA, DPS, FTM, FFR, and DBS.

In some embodiments, the bandwidth applicable for a feature can be either the nominal channel width or the extended channel width indicated by the AP. In such embodiments, the AP can transmit a control field in a broadcast or unicast frame to indicate for each UHR feature (e.g., or a feature beyond UHR) of the AP whether the nominal or extended channel width apply. In some examples, the broadcast frame can be an example of a beacon frame, probe response frame, or an association (e.g., reassociation) response frame. In one embodiment, the signaling for the specific feature is included in an extended channel width element as illustrated with respect to FIGS. 10A and 10B.

For example, FIG. 10A illustrates an extended channel width element 1000 that includes an element ID 1002, a length 1004, an element ID extension 1006, control information 1008, extended channel width list 1010, ECCFS0 list 1012, and ECCFS1 list 1014. In one embodiment, the element ID 1002 and the element ID extension 1006 can identify the extended channel width element 1000. In at least one embodiment, the length 1004 indicates a size of the extended channel width element 1000.

In one embodiment, the feature specific indications can be carried in a single information element (e.g., the extended channel width element 1000) that contains an indication of the extended bandwidths applicable for all of the features. For example, the control information 1008 can include a bit dedicated to each feature. For example, the control information 1008 can include an indication for NPCA 1016, DPS 1018, FTM 1020, FFR 1022, and a reserved field 1024. In at least one embodiment, a bit for a respective feature in the control information field 1008 can be set to one ‘1’ to indicate an extended channel width is applicable for that feature. In such embodiments, the bit for the respective feature can be set to a zero ‘0’ to indicate that the AP does not want to use the feature or that the feature uses an applicable bandwidth that is the same as the nominal bandwidth. For example, if the AP utilizes an extended bandwidth for NPCA, then the AP can set a bit having a value ‘1’ in the NPCA 1016 field. Similarly, if the AP utilizes an extended bandwidth for DPS, FTM, or FFR, the AP can set a bit having a value ‘1’ in the DPS field 1018, FTM field 1020, and FFR field 1022. In some embodiments, if the AP does not utilize the extended bandwidth for NPCA, the DPS, FTM, or FFR, the AP can set a bit having a value ‘0’ in the respective NPCA field 1016, DPS field 1018, FTM field 1020, and FFR field 1022.

In at least one embodiment, extended channel width list 1010 can include an extended channel width for each applicable feature. In at least one embodiment, an extended channel width for a feature is present only if the bit for the applicable feature is set to ‘1’—e.g., the extended channel width for a feature is not present if the bit for the applicable feature is set to ‘0’. In at least one embodiment, if the control information field 1008 is set to ‘1’ for a feature, and this bit is the ‘i^{th}’ bit that is set to ‘1’ in the control field 1008, then a corresponding channel width is indicated in the ‘i^{th}’ extended channel width field of the extended channel width list 1010. For example, if NPCA, DPS, and FTM are all present (e.g., there is a bit having a value ‘1’ in the NPCA field 1016, DPS field 1018, and FTM field 1020), then a third bit having a value ‘1’ (e.g., the bit associated with the FTM field 1020) corresponds to a third extended channel width field—e.g., to extended channel width for FTM 1030. Accordingly, the extended channel width list 1010 can include the extended channel widths for various features—e.g., include an extended channel width for NPCA field 1016, an extended channel width for DPS field 1018, an extended channel width for FTM field 1020, an extended channel width for FFR field 1022, and reserved field 1024 that can indicate additional features.

In at least one embodiment, the extended channel width element 1000 can also include the ECCFS0 list 1012 and EFFCS1 list 1014. In one embodiment, the ECCFS0 list 1012 and ECCFS1 list 1014 indicate the channel center frequencies (per primary and secondary segments0 for each of the features. For example, the EFFCS0 list 1012 can include a ECCFS0 for NPCA 1036, ECCFS0 for DPS 1038, ECCFS0 for FTM 1040, ECCFS0 for FFR 1042, and reserved field 1044 for additional features. In some embodiments, the ECCFS1 list 1014 can similarly provide the ECCFS1 for each feature. Accordingly, FIG. 10A illustrates an extended channel width element that first indicates if a features is present, than indicates the features extended bandwidth, then the features ECCFS0, and finally the features ECCFS1.

Referring to FIG. 10B, the extended channel width element 1050 illustrates an alternative format for indicating the extended bandwidths for each applicable feature. For example, the extended channel width element 1050 can be a new element transmitted by the AP in at least one of a Beacon, Probe Response, Association Response frames or individually addressed Action frames. In some embodiments, the extended channel width element 1050 can include an element ID 1052, a length 1054, an element ID extension 1056, control information 1058, and an extended channel width list 1060. In at least one embodiment, the element ID 1052 and the element ID extension 1056 can identify the extended channel width element 1050. In at least one embodiment, the length 1004 indicates a size of the extended channel width element 1050.

In at least one embodiment, the extended channel width list 1060 can include one or more feature channel width fields—e.g., include feature channel width 1 1062, feature channel width 2 1064, etc., and a reserved field 1068. In one embodiment, each feature channel width (for example feature channel width 2 1064 as illustrated in FIG. 10B) can include a control ID 1070, an extended channel width 1072, an ECCFS0 field 1074, ECCFS1 field 1076, and one or more reserved fields 1078. In one embodiment, the control ID 1070 can include one or more bits (e.g., include 8 bits) that can indicate a specific feature—e.g., indicate NPCA, DPS, DSO, FFR, DBS, etc. In some embodiments, the control ID 1070 can also be called a feature ID. In some embodiments, the extended channel width 1072 can indicate the non-nominal operating bandwidth for the applicable feature, ECCFS0 1074 can indicate the primary channel center frequency for the applicable feature, and ECCFS1 1076 can indicate the secondary channel center frequency for the applicable feature. In some embodiments, the ECCFS0 1074 and ECCFS1 1076 field are not present within the feature channel width field. In some embodiments, the feature channel width 1 1062, feature channel width 2 1064, etc., can be sub-elements of the extended channel width element 1050.

In other embodiments, the AP can utilize feature-specific elements or fields during an operation. In some embodiments, the AP can include extended channel width information (e.g., an extended or reduced operating bandwidth) within the feature-specific elements or fields. In some embodiments, the AP can include the feature specific elements or fields in broadcast or individually address frames to STAs, when the AP is using the feature.

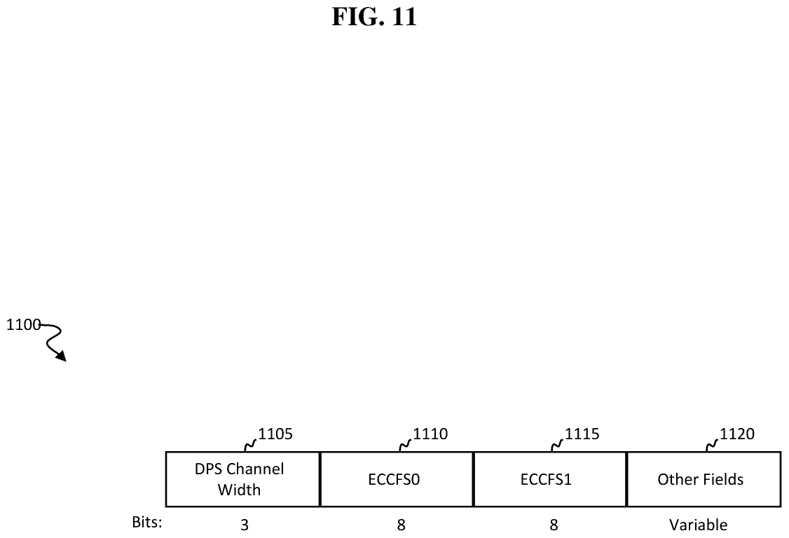

For example, FIG. 11 illustrates a DPS control element 1110 utilized during a DPS mode or operation. The format depicted in FIG. 11 is for explanatory and illustration purposes. FIG. 11 does not limit the scope of this disclosure to any particular implementation.

In at least one embodiment, the AP can operate in a dynamic power save (DPS) mode. In such embodiments, the AP can transmit a DPS control element 1110 in a beacon frame, probe response, and/or association (reassociation) response frames that the AP transmits. In one embodiment, the DPS control element 1100 can include a DPS channel width 1105, an ECCFS0 1110, an ECCFS1 1115, and other fields 1120.

In one embodiment, the DPS channel width 1105 indicates an extended bandwidth applicable to the DPS operation. In one embodiment, ECCFS0 1110 indicates a channel number of a center frequency of a primary contiguous segment of the extended DPS channel width. In some embodiments, the ECCFS0 1110 field is 8 bits. In one embodiment, ECCFS1 1115 indicates a center frequency of a secondary contiguous segment of the extended DPS channel width. In some embodiments, the ECCFS1 1115 field is 8 bits. In some embodiments, the other fields 1120 can include additional information related to the DPS operation.

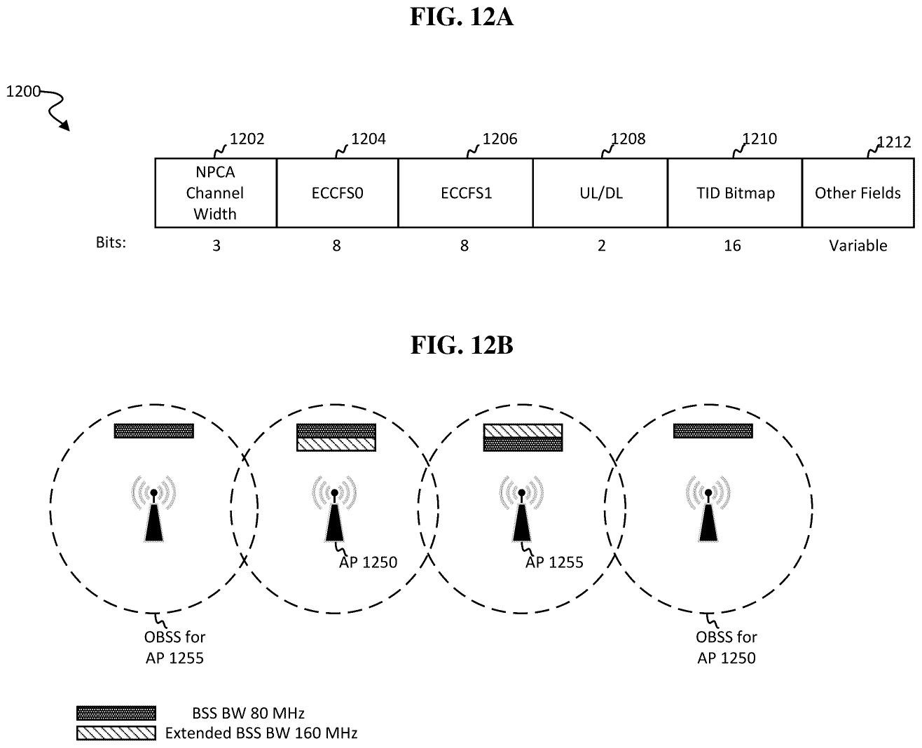

In another embodiment, FIG. 12A illustrates a NPCA control element 1200 utilized during a NPCA mode or operation. The format depicted in FIG. 12A is for explanatory and illustration purposes. FIG. 12A does not limit the scope of this disclosure to any particular implementation.

In some embodiments, the AP can operate in a non-primary channel access (NPCA) mode. In such embodiments, the AP can allow transmissions outside of the nominal operating bandwidth of the BSS if a primary channel of the AP is blocked due to an OBSS transmission. For example, the AP can enable the transmission to happen with channel access on a backup primary channel operating at an applicable NPCA channel width. In one embodiment, the NPCA backup primary channel can be outside the nominal bandwidth of the BSS but within an extended bandwidth of the BSS. In such embodiments, the AP can transmit the NPCA control element 1200 in a beacon frame, probe response, and/or association (e.g., reassociation) response frame to enable the feature. In some embodiments, the NPCA channel width is larger than the nominal bandwidth, smaller than the nominal bandwidth, or discontinuous with the nominal bandwidth. That is, the NPCA channel width can be an extended bandwidth or a reduced bandwidth.

In one embodiment, the NPCA control element 1200 can include an NPCA channel width 1202, an ECCFS0 1204, and ECCFS1 1206, an uplink/downlink 1208, a traffic identifier (TID) bitmap 120, and other fields 1212. In one embodiment, the NPCA channel width 1202 can indicate an operation bandwidth applicable for the NPCA mode or operation. In one embodiment, ECCFS0 1204 indicates a channel number of a center frequency of a primary contiguous segment of the extended NPCA channel width. In some embodiments, the ECCFS0 1202 field is 8 bits. In one embodiment, ECCFS1 1204 indicates a center frequency of a secondary contiguous segment of the extended NPCA channel width. In some embodiments, the ECCFS1 1204 field is 8 bits. In some embodiments, the UL/DL 1208 indicates whether eligible transmissions for using the extended channel width are uplink transmissions, downlink transmissions, or both. In some embodiments, TID bit 1210 identifies the TIDs that are allowed to be used for the transmission during the channel access on the backup channel. In some examples, a 20 MHz NPCA backup primary channel can also be indicated in the NPCA control element 1200.

FIG. 12B illustrates a wireless system using NPCA according to an embodiment described herein. In one embodiment, FIG. 12A illustrates a first AP 1250 and a second AP 1255. In some embodiments, an overlapping basic service set (OBSS) is shown for the first AP 1250 and first AP 1255. For example, the OBSS for second AP 1255 is shown overlapping the BSS of the first AP 1250 and the OBSS for first AP 1250 is shown overlapping the BSS of the second AP 1255. In some embodiments, the BSS of first AP 1250 operates at a primary channel width 80 MHz. In some embodiments, the BSS of the second AP 1255 also operates at the primary channel width 80 MHz. In such embodiments, the OBSS for the second AP 1255 and the OBSS for the first AP 1250 can also be associated with the 80 MHz channel width. In one embodiment, the first AP 1250 is neighboring the second AP 1255. In such embodiments, the first AP 1250 and the second AP 1255 can have orthogonal nominal BSS bandwidths to reduce the channel access delay. In such examples, though, the extended bandwidth used for NPCA (e.g., 160 MHz) overlaps with the other AP's nominal BSS bandwidth. Accordingly, the extended bandwidth is used for NPCA when the primary channel is blocked by the OBSS transmission for the first AP 1250 or for the second AP 1255. In some embodiments, to utilize the NPCA, the first AP 1250 or the second AP 1255 can transmit a NPCA control element 1200 as described with reference to FIG. 12A.

In some embodiments, the AP can be capable of a fine time measurement (FTM) operation. In such embodiments, the AP can transmit an indication of a maximum bandwidth for the FTM measurement the AP can support. In some embodiments, the AP can transmit the maximum bandwidth in the AP's capabilities element in a max FTM bandwidth field, for example. In some embodiments, the AP can transmit the max FTM bandwidth to STAs in broadcast frames, such as Beacon frames, Probe Response frames, or Association Response frames. In such embodiments, an initiating STA initiates an FTM negotiation with an AP by transmitting an initial FTM request frame. In some embodiments, the STA can request for an FTM bandwidth up to the maximum bandwidth for FTM measurement value indicated by the AP. In such embodiments, the STA can transmit the request in a format and bandwidth field of an FTM parameters element or in a ranging parameters element of the initial FTM request frame.

In other embodiments, when the AP is capable of FTM operations, the maximum bandwidth for FTM measurements that the AP can support can be the extended channel width indicated by the AP in an operation element (e.g., operation element 800 or 850 as described with reference to FIGS. 8A and 8B, respectively) or the supported channel width indicated by the AP in the AP's capability element. Accordingly, when an initiating STA initiates FTM negotiations with an AP by transmitting an initial FTM request, the STA can request an FTM bandwidth up to the extended channel width or the supported channel width indicated by the AP. In some embodiments, the STA can transmit the request in a format and bandwidth field of an FTM parameters element or in a ranging parameters element of the initial FTM request frame.

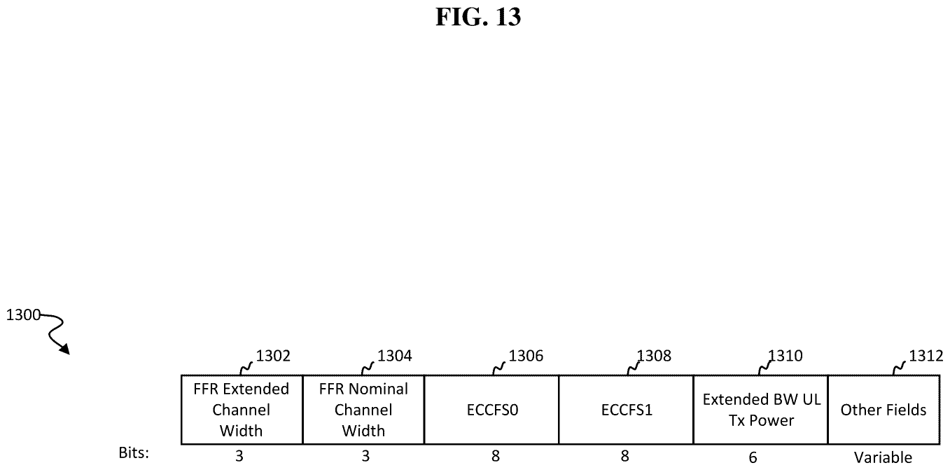

In another embodiment, FIG. 13 illustrates an FFR control element 1300 utilized during an FFR mode of operation. The format depicted in FIG. 13 is for explanatory and illustration purposes. FIG. 13 does not limit the scope of this disclosure to any particular implementation. In some embodiments, the AP can operate in a fractional frequency reuse (FFR) mode. In such embodiments, the AP can include the FFR control element 1300 in a beacon frame, probe response frame, and/or association (e.g., reassociation) response frame.

In one embodiment, the FFR control element 1300 can include an FFR extended channel width 1302, an FFR nominal channel width 1304, an ECCFS0 1306, ECCFS1 1308, an extended bandwidth uplink transmission (UL Tx) power 1310, and other fields 1312. In one embodiment, the FFR extended channel width 1302 indicates an extended bandwidth applicable to the FFR operation. In one embodiment, the FFR nominal channel width 1304 indicates a nominal bandwidth supported during the FFR operation. In at least one embodiment, ECCFS0 1306 indicates a channel number of a center frequency of a primary contiguous segment of the extended FFR channel width. In some embodiments, the ECCFS0 1306 field is 8 bits. In one embodiment, ECCFS1 1308 indicates a center frequency of a secondary contiguous segment of the extended FFR channel width. In some embodiments, the ECCFS1 1308 field is 8 bits. In at least one embodiment, the extended BW UL Tx power 1310 indicates a maximum allowed transmit power when using the FFR extended bandwidth for transmission. In some embodiments, the maximum allowed transmit power can have units of dBm/20 MHz. In at least one embodiment, the other fields 1312 include additional information related to the FFR operation.

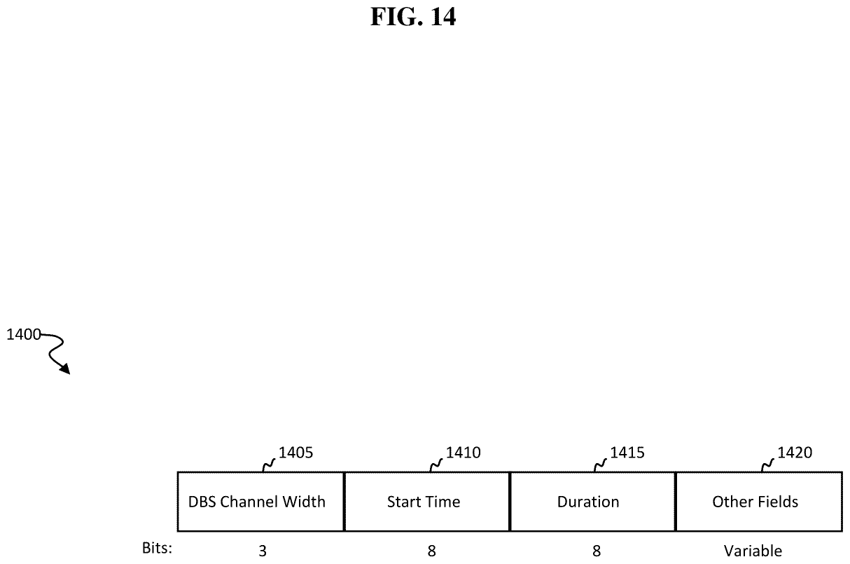

In another embodiment, FIG. 14 illustrates an DBS control element 1400 utilized during a DBS mode or operation. The format depicted in FIG. 14 is for explanatory and illustration purposes. FIG. 14 does not limit the scope of this disclosure to any particular implementation.

In some embodiments, the AP can perform a dynamic bandwidth selection (DBS) operation. In such embodiments, the AP can broadcast a notification frame or element that includes several fields indicating an upcoming change in UHR operating bandwidth of the AP to associated STAs that support DBS. In some embodiments, the DBS notification can be carried in a new action frame, carried in an existing element such as the multi-link reconfiguration element, or can be carried in a new DBS specific element that is included in broadcast frames transmitted by the AP. In some embodiments, the indication can be carried in a DBS-specific sub-element of a new UHR element. In some embodiments, the DBS notification can include a start time of the change and/or a duration of the time for which the changed operating channel width is expected to be applicable. In some embodiments, the DBS notification can be included in a DBS control element 1400.

In such examples, the DBS control element 1400 can include a DBS channel width 1405, a start time 1410, a duration 1415, and other fields 1420. In at least one embodiment, the DBS channel width 1405 can indicate the extended operating bandwidth applicable for the DBS operation. In some embodiments, the start time 1410 can indicate a start time of a change in the operating bandwidth of the AP. In at least one embodiment, the duration 1415 indicates a duration of time for which the AP is utilizing the changed operating bandwidth. In some examples, the start time 1410 and the duration 1415 can be indicated in units of target beacon transmit times. In some examples, the other fields 1420 can include additional information regarding the DBS operation.

In other embodiments, the AP can also include time indications associated with the extended bandwidth. That is, in some embodiments, the extended bandwidth for a feature is applicable on a temporary basis for a fixed duration of time from the indication. In such embodiments, the AP can transmit an indication of a remaining time for which the extended bandwidth use is allowed. In some embodiments, the AP can include the indication of the remaining time in an ‘extended bandwidth (BW) duration’ field in the feature specific element or field. In some examples, the timing indication can be in units of target beacon transmit times (TBTTs). In some embodiments, the timing indication can be used for DBS operations, for example.

In at least one embodiment, the extended bandwidth for a feature is applicable during periodic service periods. Accordingly, a start time, duration, and periodicity of the service periods can be indicated in the feature specific elements or fields transmitted by the AP. For example, the service periods can be associated with a target wake time (TWT) schedule. In such embodiments, a TWT identification (ID) corresponding to the schedule can be included in the feature specific elements or fields. In other embodiments, a TWT element corresponding to the service periods can include an indication of whether the TWT service period is eligible to use the extended bandwidth of the BSS. In some embodiments, the TWT element can include a direct indication of the bandwidth that can be used for that respective TWT service period.

In at least one embodiment, the AP (e.g., or associated STAs), can perform cross-BSS extended bandwidth coordination That is, while the AP or the associated STAs use the extended bandwidth, there can be overlap with a neighboring AP's primary channel, causing channel access delay for the neighboring AP. Accordingly, a first AP can perform multi-AP coordination signaling with a second neighboring AP to ensure that the extended bandwidth transmission from the second AP's BSS does not significantly degrade performance of the first AP's BSS. In some embodiments, the first AP can perform the multi-AP coordination by transmitting signaling in an action frame. In such embodiments, the action frame can include an indication of the 20 MHz channels which may have been punctured by the STAs of the second AP's BSS when transmitting in the extended bandwidth mode. In some embodiments, the action frame can also include an indication of a set of STAs belonging to the second AP's BSS that may be disallowed from using the extended bandwidth. For example, for an FFR operation, STAs that are too close to the first AP's BSS may be disallowed from using the extended bandwidth and thus indicated in the action frame. In at least one embodiment, the STAs that are too close can be identified from the transmitting (Tx) or receiving (Rx) MAC address of the frames observed by the first AP that cause high channel access delay to the channel. In at least one embodiment, the action frame can also include an indication of a specific duration of time (e.g., a time starting from the indication) or periodic service periods during which the extended bandwidth transmission may not be used by the STAs of the second AP's BSS. In at least one embodiment, the action frame also includes a specific duration of time (e.g., a time starting from the indication) or periodic service periods during which the extended bandwidth transmission may be used by the STAs of the second AP's BSS.

In one or more embodiments, the AP can ensure that to use the extended channel width, a recipient STA can anticipate a transmission time of frames using the extended channel width. For example, for an NPCA operation, the STA can anticipate the time for using the extended channel width based on a trigger condition for the NPCA channel switch being satisfied. In another example, for a DBS operation, the STA can anticipate the time for using the extended bandwidth based on the service periods, start time, or end time of using the extended channel announced by the AP. In at least one embodiment, for FTM operations, the STA can anticipate the time for using the extended channel based on the negotiated burst duration and burst period or the negotiated availability windows with the AP.

In one embodiment, the AP can aid the STA in anticipating the time for using the extended bandwidth. For example, the AP can indicate if an STA, that is initiating transmission with the AP with the extended channel, needs to initiate the transmission with an applicable initial control frame. In one embodiment, the initial control frame can be sent in a non-HT duplicate PPDU format with any applicable padding. In one embodiment, the AP can transmit the control frame for a DPS operation. In another embodiment, either the initiating STA or the responding STA, during an FTM negotiation process, can indicate that FTM measurement exchanges should be preceeded by an appropriate initial control frame exchange—e.g., for certain FTM operations, such as non-trigger based FTM ranging, the initiating or responding STA can request the initial control frame transmission before transmission of the FTM frames. In some embodiments, new fields can also be defined in the initial FTM exchange frames during the FTM negotiation procedure to include the indication. In some examples, new and additional frames fields can be defined for indicating the change in the middle of an already ongoing negotiated FTM session. In some embodiments, the AP can also precede the transmission of the FTM measurement exchange that utilizes the extended bandwidth with a transmission of an appropriate initial control frame.

In at least one embodiment, an STA can also request the AP to include the initial control frame with sufficient padding if initiating transmission with the STA on the extended bandwidth capability. In some embodiments, an STA that supports the feature but not the bandwidth capability (e.g., the STA's supported bandwidth indicated in the capabilities element is less than the extended bandwidth capability) can enable a dynamic sub-channel operation (DSO) to enable being scheduled on the indicated extended channel width.

In some embodiments, the AP can also indicate some information to a neighbor AP regarding conditions for the use of extended bandwidth channel via an initial control frame when initiating transmissions in a TXOP over the extended bandwidth. For example, for a NPCA operation, the AP can disclose it is using the extended bandwidth due to the primary channel being occupied by an OBSS transmission. In such embodiments, the AP can further specify the OBSS AP's MAC address or BSS color. In one embodiment, the neighboring AP can use the information for its own NPCA operation during the TXOP.

In at least one embodiment, the AP can perform resource unit (RU) allocation differently when using extended bandwidth. For example, when the AP performs downlink transmissions or solicited triggered uplink transmissions for a feature with orthogonal frequency division multiple access (ODFMA), if the TXOP bandwidth is not within the nominal bandwidth but is within the extended bandwidth of the feature, the AP can perform RU allocation as follows: for addressed STAs that do not support the feature, the RU allocation index corresponding to the nominal bandwidth can be used for RU indications; and for the addressed STAs that support the feature corresponding to the extended bandwidth, the RU allocation index corresponding to the TXOP bandwidth can be used for the RU indications.

In another embodiment, the RU allocation index corresponding to the smallest bandwidth that occupies both the primary 20 MHz channel of the AP and the TXOP bandwidth may be used for RU indication for the addressed STAs that support the feature. In at least one embodiment, the STAs that do not support the feature or the use of extended bandwidth may not be included in the OFDMA transmission over a PDDU that occupies the extended bandwidth.

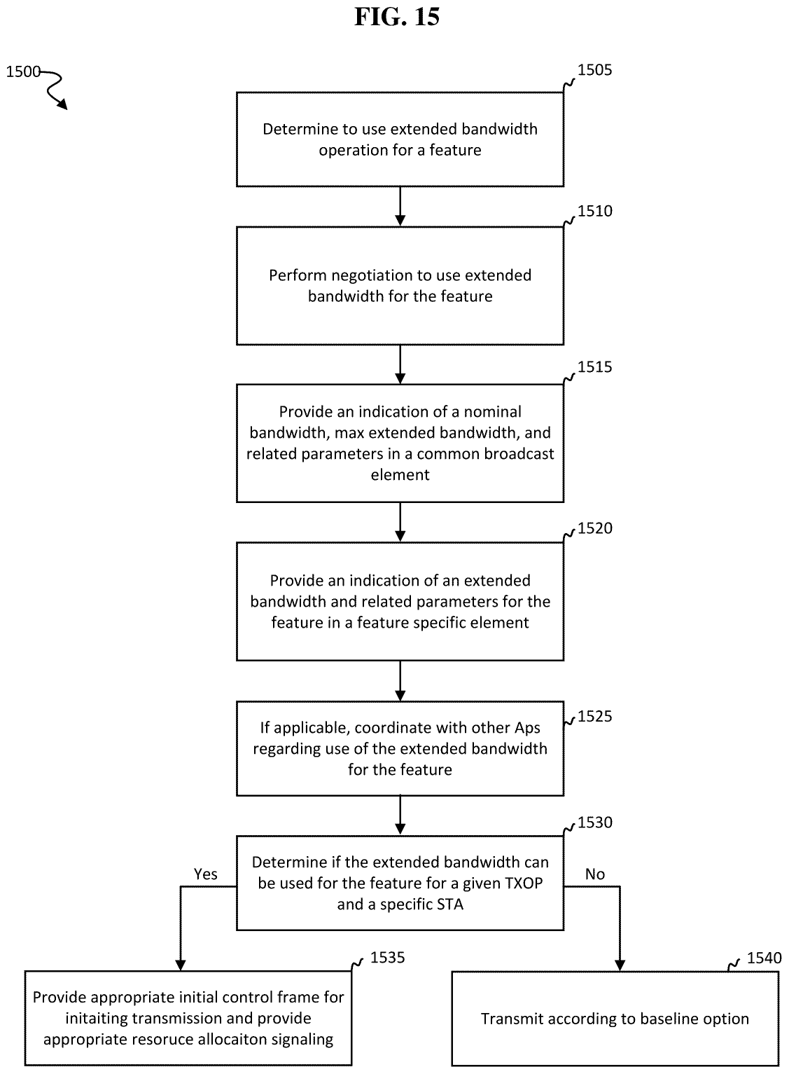

FIG. 15 shows an example process 1500 for using an extended bandwidth in accordance with an embodiment. For explanatory and illustration purposes, the process 1500 may be performed by an AP. Although one or more operations are described or shown in a particular sequential order, in other embodiments the operations may be rearranged in a different order, which may include performance of multiple operations in at least partially overlapping time periods.

Referring to FIG. 15, the process 1500 may begin in operation 1505. In operation 1505, an AP determines to use an extended bandwidth operation for a feature. For example, as described above with reference to FIG. 8A, certain operation performed by the AP may be at a bandwidth that is higher or lower than a nominal bandwidth used. In at least one embodiment, the nominal bandwidth can be a bandwidth applicable to all of the associated STAs. It should be noted that although the extended bandwidth is discussed, it could also be a reduced bandwidth for the feature—e.g., the AP can determine to use a non-nominal bandwidth for the feature. In at least one embodiment, the feature can be an example of a non-primary channel access (NPCA), dynamic power save (DBS), a fine time measurement (FTM), a fractional frequency reuse (FFR), a dynamic bandwidth selection (DBS), a dynamic bandwidth expansion (DBE) (e.g., another naming convention for the DBS operation), or any other feature that uses a non-nominal bandwidth.

In operation 1510, the AP performs negotiations to use the extended bandwidth for the feature. In some embodiments, the AP can negotiate with other AP's regarding the usage of the extended bandwidth. In other embodiments, the AP can negotiate with one or more associated STAs to use the extended bandwidth.

In operation 1515, the AP provides an indication of a nominal bandwidth, a maximum extended bandwidth (e.g., or a minimum reduced bandwidth), and related parameters in a common broadcast element. In at least one embodiment, the AP can refrain from transmitting the nominal bandwidth—e.g., the nominal bandwidth can be implied. In such embodiments, a STA receiving the indication without the nominal bandwidth can determine the nominal bandwidth from a previously received operations element—e.g., from an operation element associated with a previous Wi-Fi generation. For example, the STA can determine the nominal bandwidth from an EHT field. In some embodiments, where multiple operation elements are present, the associated STA can determine the nominal bandwidth according to an order. One example of the order can be the STA first looks at an EHT operation element, if not present then look at an HE operation element, if not present then look at a VHT element, if not present then look at an HT element—e.g., EHT>HE>VHT>HT. In some embodiments, the related parameters for the maximum extended bandwidth can be statistics associated with the usage of the extended bandwidth (e.g., as described with reference to FIG. 8B), a time indication for the extended bandwidth, or RU allocation information associated with the extended bandwidth. In at least one embodiment, the related parameters can include feature specific information or whether a feature utilizes the extended bandwidth as described with reference to FIGS. 10A and 10B.

In operation 1520, the AP provides an indication of an extended bandwidth and related parameters for the feature in a feature specific element. In some embodiments, the AP can include the extended bandwidth in a feature specific element while performing an operation corresponding to the feature. That is, the AP can include the extended bandwidth for a feature when executing the respective feature as described with reference to FIGS. 11-14.

In operation 1525, the AP (if applicable), coordinates with one or more neighboring APs regarding the use of the extended bandwidth for the feature. In at least one embodiment, the AP can coordinate with the neighboring AP before transmitting data using the extended bandwidth. That is, the AP can perform multi-AP coordination to request to use the bandwidth to a neighboring AP whose operating bandwidth overlaps with the extended bandwidth of the AP as described with reference to FIGS. 10A and 10B. In other embodiments, the AP determines the neighboring AP is already interfering and can request the neighboring AP to refrain from using the extended bandwidth for a respective duration as described with reference to FIG. 14.

In operation 1530, the AP determines if the extended bandwidth can be used for the feature for a given transmission opportunity (TXOP) and a specific STA. In at least one embodiment, the AP determines the extended bandwidth can be used and proceeds to operation 1535. In other embodiments, the AP determines the extended bandwidth cannot be used and proceeds to operation 1540.

In operation 1535, the AP can provide an appropriate initial control frame for initiating a transmission and provide appropriate resource allocation signaling as described with reference to FIG. 14.

In operation 1540, the AP can transmit according to a baseline operation. That is, the AP can refrain from using the extended bandwidth for the feature and proceed with using the nominal bandwidth.

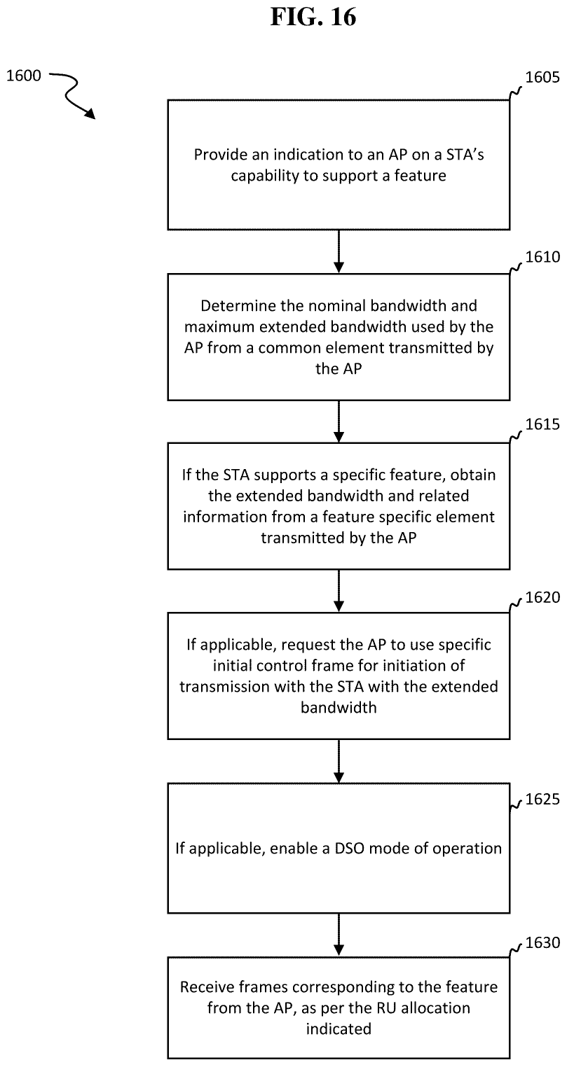

FIG. 16 shows an example process 1600 for using an extended bandwidth in accordance with an embodiment. For explanatory and illustration purposes, the process 1600 may be performed by a non-AP station (STA). Although one or more operations are described or shown in a particular sequential order, in other embodiments the operations may be rearranged in a different order, which may include performance of multiple operations in at least partially overlapping time periods.

Referring to FIG. 16, the process 1600 may begin in operation 1605. In operation 1605, the STA provides an indication to an AP on a STA's capability to support a feature. In some embodiments, the STA can indicate a maximum bandwidth the STA can support. In other embodiments, the STA can refrain from transmitting the indication—e.g., the AP can transmit universal messages without knowing the capabilities of the STAs, and each STA can receive and decode the message to utilize the extended bandwidth if applicable.

At operation 1610, the STA can determine the nominal bandwidth and a maximum extended bandwidth used by the AP from a common element transmitted by the AP. In at least one embodiment, the STA can also determine a minimum reduced extended bandwidth from the common element transmitted by the AP. In some embodiments, the AP can refrain from transmitting the nominal bandwidth. In such embodiments, the STA can determine the nominal bandwidth from a previous operation element channel width. In some embodiments, if multiple operations elements are present, the STA can determine the nominal bandwidth according to an order as described with reference to FIGS. 10A and 10B—e.g., EHT>HE>VHT>HT.

In operation 1615, if the STA supports a specific feature, the STA can obtain the extended bandwidth and related information from a feature specific element transmitted by an AP. That is the STA can identify an extended bandwidth within a feature specific element as described with reference to FIGS. 11-14. In other embodiments, the STA can determine the extended bandwidth for the feature based on the common element transmitted by the AP—e.g., if the common element include the feature specific information as described with reference to FIGS. 10A and 10B, the STA can determine the feature specific information based on receiving the common element. For example, the common element can indicate whether a feature utilizes the nominal bandwidth or the extended bandwidth. In other embodiments, the common element can include a specific extended bandwidth for a respective feature.

In operation 1620, the STA (if applicable), requests the AP to use specific initial control information for initiation of the transmission with the STA on the extended bandwidth as described with reference to FIG. 14—e.g., the STA can request the AP indicate when the AP is going to utilize the extended bandwidth.

In operation 1625, the STA can enable a dynamic subchannel operation, if applicable. That is, in some embodiments, the STA can be capable of performing DSO mode of operation. In such embodiments, the STA can be capable of switching their radio dynamically from a primary subchannel to a secondary subchannel, or vice versa. In some embodiments, the STA can enter the DSO mode of operation to enable the STA to utilize the extended bandwidth.

In operation 1630, the STA can receive the frames corresponding to the feature from the AP, as per the RU allocation indicated—e.g., the RU allocations can be allocated as described with reference to FIG. 14. In that, for addressed STAs that do not support the feature, the RU allocation index corresponding to the nominal bandwidth can be used for RU indications and for the addressed STAs that support the feature corresponding to the extended bandwidth, the RU allocation index corresponding to the TXOP bandwidth can be used for the RU indications.

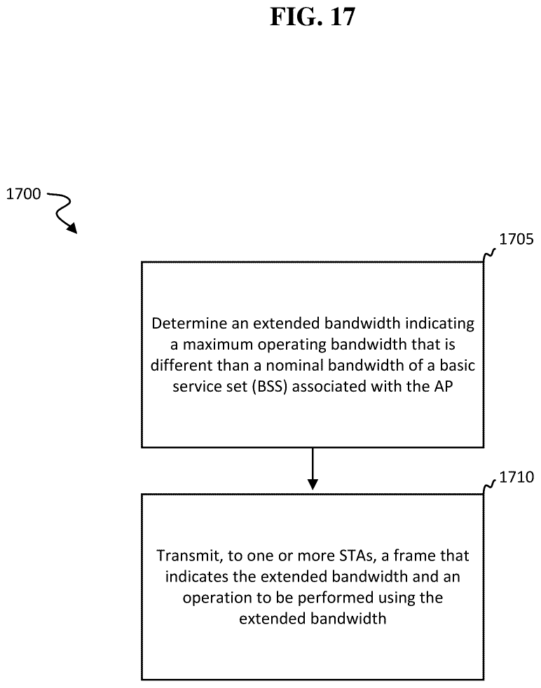

FIG. 17 shows an example process 1700 for using an extended bandwidth in accordance with an embodiment. For explanatory and illustration purposes, the process 1700 may be performed by an access point (AP). In some embodiments, some operations of process 1700 can be performed by a station (STA). Although one or more operations are described or shown in a particular sequential order, in other embodiments the operations may be rearranged in a different order, which may include performance of multiple operations in at least partially overlapping time periods.

Referring to FIG. 17, the process 1700 may begin in operation 1705. In operation 1705, a processor is to determine an extended bandwidth indicating a maximum operation bandwidth that is different than a nominal bandwidth of a basic service set (BSS) associated with the AP. In some embodiments, the extended bandwidth is determined based on an operating bandwidth of an operation supported by the AP and one or more associated STAs. In at least one embodiment, the extended bandwidth can be a maximum operating bandwidth for any operation performed by the AP or by an associated STA. In some embodiments, the AP can transmit a request frame to an STA including a request to inform the AP of the STA's capabilities. In at least one embodiment, the STA capabilities can include a maximum operating bandwidth of the STA. Accordingly, in some examples, the AP can determine the extended bandwidth based on the capabilities of the associated STAs. In at least one example, the AP could also determine the nominal bandwidth for the BSS. In such embodiments, the AP can transmit a frame to the STAs including the nominal bandwidth.

In operation 1710, the AP is to transmit, to one or more STAs, a frame that indicates the extended bandwidth and an operation to be performed using the extended bandwidth. In at least one embodiment, the AP can transmit a second frame including an operation element indicating a channel width, where the processor is to determine the nominal bandwidth based at least in part on the channel width. In some embodiments, the channel width is included in the frame. In at least one embodiment, the STA can receive, from the AP, the second frame including the operation element indicating the channel width and determining the nominal bandwidth based on the channel width. In some examples, the second frame includes a plurality of operation elements indicating a plurality of channel widths, where the plurality of operation elements includes the operation element indicating the channel width. In such examples, the STA determines the nominal bandwidth associated with the STA based at least in part on an order the plurality of operation elements is decoded. That is, as described with reference to FIG. 8B, in some embodiments, the nominal channel width is not indicated. In such embodiments, a channel width applicable to transmissions (e.g., UHR transmissions) can be the same as a channel width indicated of one or more pre-UHR operation elements. In some embodiments, when multiple pre-UHR operation elements are present, the order of precedence for the nominal channel width can be EHT>HE>VHT>HT—e.g., the channel width in the EHT operations element>the channel width in the HE operations element>the channel width in the VHT operations element>the channel width of the HT operations element.

In at least one embodiment, the frame includes information to indicate whether the extended bandwidth is present—e.g., the frame can include an extended channel width present field 832 as described with reference to FIG. 8B. In such embodiments, the AP can set a bit to a first or second value indicating whether the extended bandwidth is present or not, respectively. In at least some embodiments, the frame can include information to indicate a center frequency of different segments of the extended bandwidth.

In at least one embodiment, the AP can transmit, to a second AP, a request frame including the extended bandwidth and a request to utilize the extended bandwidth on an indicated channel for a duration. In such embodiments, the AP can receive, from the second AP, a response indicating whether the request is accepted or rejected by the second AP. That is, in some embodiments, the AP can perform multi-AP or cross-BSS coordination as described with reference to FIGS. 8A and 14. For example, before the AP initiates a transmission with on the extended bandwidth, the AP can initiate a multi-AP coordination request to a neighboring AP whose operating bandwidth overlaps with the extended bandwidth transmission of the AP. In such examples, the AP can request to use the extended bandwidth (e.g., request to use the extended bandwidth at a certain time or indicate channel the second AP should refrain from using, etc.). In some embodiments, the second AP can receive request and transmit a response frame. That is, the AP can receive the response frame indicating whether the request is accepted or rejected by the second AP. In some examples, the second AP can provide alternate times or alternate extended bandwidths the AP can utilize. In other embodiments, the AP can determine the second AP is interfering with the AP perform multi-AP coordination to ensure that it does continue to interfere in a significant manner. Accordingly, the AP can include information about channels and times the AP is utilizing the extended bandwidth.

In some embodiments, the AP can transmit a second frame that includes one or more statistics indicative of a usage of the extended bandwidth and the nominal bandwidth. That is, the AP can include air-time usage of the nominal and/or extended bandwidth within the AP's BSS as described with reference to FIG. 9. In some embodiments, the AP can transmit the statistics to a neighboring UHR AP. In such embodiments, the neighboring AP can perform roaming using the statistics. In other embodiments, the AP can transmit the statistics to UHR non-AP STA. In such embodiments, the STA can utilize the statistics to make a roaming decision.

In at least one embodiment, the frame includes one or more fields associated with the operation indicating whether the operation utilizes the nominal bandwidth or the extended bandwidth. That is, as described with reference to FIG. 10A, the frame can include an indication for each operation for a plurality of operations supported by the AP, where each indication indicates whether the operation uses the extended bandwidth or not. For example, the control information field can include a NPCA subfield indicating whether the NPCA operation is at the extended bandwidth. In other embodiments, the frame includes the one or more fields associated with the operation indicating a bandwidth applicable for the operation. That is, as described with reference to FIG. 10B, in some embodiments, the parameters for each operation are included in an operation list. In some embodiments, an indicated bandwidth for an operation can between the nominal bandwidth and the extended bandwidth.

In at least one embodiment, the processor is further to transmit an element or field associated with the operation within the frame or a second frame based at least on initiating the operation, where the element or field includes an indication of the extended bandwidth for the operation. That is, the AP can transmit the frame with operation specific elements or fields indicating parameters for the operation including the extended bandwidth. In that, as described with reference to FIGS. 11-14, the extended bandwidth can be included in feature or operation specific elements transmitted by the AP during the operation or while executing the feature.

In at least one embodiment, the frame includes at least one of a start time indicating a time when the extended bandwidth is applied for a transmission and an extended bandwidth duration indicating a duration the extended bandwidth is applied for operation.

In at least one embodiment, the AP transmits a second frame using the extended bandwidth, where the second frame is preceded by a transmission of a control frame including an indication corresponding to a transmission time of a first data frame utilizing the extended bandwidth. That is, as described with reference to FIG. 14, the STA can transmit, to the AP, a request frame that request the AP initiates the operation at the extended bandwidth with an initial control frame. In such examples, the STA can receive a response from the AP indicating the request is accepted. Accordingly, the STA can receive an initial control frame prior to initiating the extended bandwidth operations.

In one or more embodiments, the frame includes a resource unit (RU) allocation, wherein the subset of the set of associated STAs is allocated to a first RU and the remaining subset of the associated STAs is allocated to a second RU. In one embodiment, the STA can determine whether the STA can perform the operation at the extended bandwidth (e.g., determine whether the STA is capable of operating at the extended bandwidth) and select an RU allocation index for RU indication from the RU allocation based in part on determining whether the STA can perform the operation at the extended bandwidth. That is, for addressed STAs that do not support the feature, the RU allocation index corresponding to the nominal bandwidth can be selected and for STAs that do support the feature, the RU allocation index corresponding to the TXOP bandwidth may be used.

The disclosure presents various embodiments signaling and using an extended bandwidth, enabling AP and STA to operate on a bandwidth different from a nominal bandwidth for a specific feature or operation.

A reference to an element in the singular is not intended to mean one and only one unless specifically so stated, but rather one or more. For example, “a” module may refer to one or more modules. An element proceeded by “a,” “an,” “the,” or “said” does not, without further constraints, preclude the existence of additional same elements.

Headings and subheadings, if any, are used for convenience only and do not limit the invention. The word exemplary is used to mean serving as an example or illustration. To the extent that the term “include,” “have,” or the like is used, such term is intended to be inclusive in a manner similar to the term “comprise” as “comprise” is interpreted when employed as a transitional word in a claim. Relational terms such as first and second and the like may be used to distinguish one entity or action from another without necessarily requiring or implying any actual such relationship or order between such entities or actions.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A phrase “at least one of” preceding a series of items, with the terms “and” or “or” to separate any of the items, modifies the list as a whole, rather than each member of the list. The phrase “at least one of” does not require selection of at least one item; rather, the phrase allows a meaning that includes at least one of any one of the items, and/or at least one of any combination of the items, and/or at least one of each of the items. By way of example, each of the phrases “at least one of A, B, and C” or “at least one of A, B, or C” refers to only A, only B, or only C; any combination of A, B, and C; and/or at least one of each of A, B, and C.

It is understood that the specific order or hierarchy of steps, operations, or processes disclosed is an illustration of exemplary approaches. Unless explicitly stated otherwise, it is understood that the specific order or hierarchy of steps, operations, or processes may be performed in different order. Some of the steps, operations, or processes may be performed simultaneously or may be performed as a part of one or more other steps, operations, or processes. The accompanying method claims, if any, present elements of the various steps, operations or processes in a sample order, and are not meant to be limited to the specific order or hierarchy presented. These may be performed in serial, linearly, in parallel or in different order. It should be understood that the described instructions, operations, and systems can generally be integrated together in a single software/hardware product or packaged into multiple software/hardware products.

The disclosure is provided to enable any person skilled in the art to practice the various aspects described herein. In some instances, well-known structures and components are shown in block diagram form in order to avoid obscuring the concepts of the subject technology. The disclosure provides various examples of the subject technology, and the subject technology is not limited to these examples. Various modifications to these aspects will be readily apparent to those skilled in the art, and the principles described herein may be applied to other aspects.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using a phrase means for or, in the case of a method claim, the element is recited using the phrase step for.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the claims. In addition, in the detailed description, it can be seen that the description provides illustrative examples and the various features are grouped together in various implementations for the purpose of streamlining the disclosure. This method of disclosure is not to be interpreted as reflecting an intention that the claimed subject matter requires more features than are expressly recited in each claim. Rather, as the following claims reflect, inventive subject matter lies in less than all features of a single disclosed configuration or operation. The following claims are hereby incorporated into the detailed description, with each claim standing on its own as a separately claimed subject matter.

The claims are not intended to be limited to the aspects described herein, but are to be accorded the full scope consistent with the language claims and to encompass all legal equivalents. Notwithstanding, none of the claims are intended to embrace subject matter that fails to satisfy the requirements of the applicable patent law, nor should they be interpreted in such a way.

What is claimed is:

1. An access point (AP) in a wireless network, comprising:
a memory; and
a processor coupled to the memory, the processor configured to cause:
determining an extended bandwidth indicating a maximum operating bandwidth that is different than a nominal bandwidth of a basic service set (BSS) associated with the AP; and
transmitting, to one or more stations (STAs), a frame that indicates the extended bandwidth and an operation to be performed using the extended bandwidth.

2. The AP of claim 1, wherein the processor is further configured to cause:
transmitting a second frame including an operation element indicating a channel width, wherein the processor is to determine the nominal bandwidth based at least in part on the channel width.

3. The AP of claim 1, wherein the processor is further configured to cause:
transmitting, to a second AP, a request frame including the extended bandwidth and a request to utilize the extended bandwidth on an indicated channel for a duration; and
receive, from the second AP, a response frame indicating whether the request is accepted or rejected by the second AP.

4. The AP of claim 1, wherein the frame includes at least one of:
information configured to indicate whether the extended bandwidth is present in the frame; or
information configured to indicate a center frequency of different segments of the extended bandwidth.

5. The AP of claim 1, wherein the processor is further configured to cause:
transmitting, to the STA, a second frame that includes one or more statistics indicative of a usage of the extended bandwidth and the nominal bandwidth.

6. The AP of claim 1, wherein:
the frame includes one or more fields associated with the operation indicating whether the operation utilizes the nominal bandwidth or the extended bandwidth; or
the frame includes the one or more fields associated with the operation indicating a bandwidth applicable for the operation.

7. The AP of claim 1, wherein the processor is further configured to cause:
transmitting an element or field associated with the operation within the frame or a second frame based at least in part on initiating the operation, wherein the element or field includes an indication of the extended bandwidth for the operation.

8. The AP of claim 1, wherein the frame includes at least one of:
a start time indicating a time when the extended bandwidth is applied for a transmission; or
an extended bandwidth duration indicating a duration the extended bandwidth is applied for operation.

9. The AP of claim 1, wherein the transmission of a second frame using the extended bandwidth is preceded by a transmission of a control frame including an indication corresponding to a transmission time of a first data frame utilizing the extended bandwidth.

10. The AP of claim 1, wherein the frame includes a resource unit (RU) allocation, wherein the subset of the set of associated STAs is allocated to a first RU and the remaining subset of the set of associated STAs is allocated to a second RU.

11. A station (STA) in a wireless network, comprising:
a memory; and
a processor coupled to the memory, the processor configured to cause:
receiving, from an access point (AP), a frame that indicates an extended bandwidth and an operation to be performed using the extended bandwidth, wherein the extended bandwidth indicates a maximum operating bandwidth that is different than a nominal bandwidth of a basic service set (BSS) associated with the AP; and
performing the operation at the extended bandwidth based at least in part on the receiving the frame.

12. The STA of claim 11, wherein the processor is further configured to cause:
receiving, from the AP, a second frame including an operation element indicating a channel width; and
determining the nominal bandwidth based at least in part on the channel width.

13. The STA of claim 12, wherein:
the second frame includes a plurality of operation elements indicating a plurality of channel widths, wherein the plurality of operation elements includes the operation element indicating the channel width; and
determining the nominal bandwidth associated with the STA based at least in part on an order the plurality of operation elements is decoded.

14. The STA of claim 11, wherein the processor is further configured to cause:
transmitting, to the AP, a request frame that requests the AP initiates the operation at the extended bandwidth with an initial control frame; and
receiving, from the AP, a response frame indicating the request is accepted.

15. The STA of claim 11, wherein the frame includes at least one of:
information configured to indicate whether the extended bandwidth is present in the frame; or
information configured to indicate a center frequency of different segments of the extended bandwidth.

16. The STA of claim 11, wherein the processor is further configured to cause:
receiving, from the AP, a second frame that includes one or more statistics indicative of a usage of the extended bandwidth and the nominal bandwidth.

17. The STA of claim 11, wherein:
the frame includes one or more fields associated with the operation indicating whether the operation utilizes the nominal bandwidth or the extended bandwidth; or
the frame includes the one or more fields associated with the operation indicating a bandwidth applicable for the operation.

18. The STA of claim 11, wherein the frame includes at least one of:
a start time indicating a time when the extended bandwidth is applied for a transmission; or
an extended bandwidth duration indicating a duration the extended bandwidth is applied for the operation.

19. The STA of claim 11, wherein the frame is an operation frame indicating parameters for the operation including the extended bandwidth.

20. The STA of claim 11, wherein the frame includes a resource unit (RU) allocation, and wherein the processor is further configured to cause:
determining whether the STA is configured to perform the operation at the extended bandwidth; and
selecting an RU allocation index for RU indication from the RU allocation based at least in part on determining whether the STA is configured to perform the operation at the extended bandwidth.
